(19) United States
(12) Patent Application Publication
(10) Pub. No.: US 2003/0191816 A1
(43) Pub. Date: Oct. 9, 2003

(54) System and method for creating and delivering customized multimedia communications

(75) Inventors: Scott Landress, Mill Valley, CA (US); John Calder, San Francisco, CA (US); Wayne Rubin, Woodmere, NY (US)

Correspondence Address: OSTROLENK FABER GERB & SOFFEN, 1180 AVENUE OF THE AMERICAS, NEW YORK, NY, 100368403

(73) Assignee: Spoovy, LLC

(21) Appl. No.: 09/757,832

(22) Filed: Jan. 10, 2001

Related U.S. Application Data
(60) Provisional application No. 60/175,521, filed on Jan. 11, 2000.
(60) Provisional application No. 60/196,404, filed on Apr. 12, 2000.

(51) Int. Cl. G06F 15/16

(52) U.S. Cl. 709/219

(57) ABSTRACT

A system and business methodology for providing interactive and customizable digital full-motion, animated and static multimedia content, to be used for communicating unique personalized entertainment, information, and messages and advertising to be delivered via the internet, electronic mail, or any other methods of delivering interpersonal communications and messages. The communications and messages are initiated and received by senders and recipients visiting a host site of the system through the internet. Content within the customized communication includes content personally relevant to a user which is integrally associated with sponsorship or advertising information. Creation of a customized communication begins by selection of a content item by a user, which content may be personalized by graphical editing techniques. Personalized or non-personalized content may be executed in parallel or in series with other content items in a multilinear playback sequence compiled according to a predetermined script to produce a finished customized multimedia communication. The host site also provides other features and products desirable to users, such as screensavers, reminder services, etc.

This application claims priority to U.S. Provisional Application Serial Nos. 60/175,521, filed on Jan. 11, 2000 and entitled “SYSTEM AND METHOD FOR CREATING AND COMMUNICATING CUSTOMIZED GREETING AND MESSAGES”, and 60/196,404, filed on Apr. 12, 2000 and entitled “SYSTEM AND METHOD FOR PROVIDING DIGITAL FULL-MOTION, ANIMATED AND STATIC MULTIMEDIA CONTENT USED FOR COMMUNICATING UNIQUE PERSONALIZED ENTERTAINMENT”.

### BACKGROUND OF THE INVENTION

1. Field of the Invention

The present invention relates to a system and method for remotely serving, tracking and optimizing the placement of a dynamic range of media content to be assembled on demand and delivered in real-time.

The present invention also relates to a unique media channel which enables the creation of short interactive digital full-motion, animated and static multimedia content for communicating personalized and/or personally relevant entertainment, messages and information content substantively and integrally associated with advertising content to be delivered via electronic delivery channels such as the Internet, wireless networks, or electronic mail (e-mail).

2. Description of the Related Art

The emergence of higher bandwidth technology and tighter compression methods are enabling an increasing amount of data to be transmitted at an increasing rate of speed. This growth is simultaneously accompanied by the development of increasingly complicated applications, particularly in entertainment media. For example, animation graphics are moving closer and closer to real-time and are becoming more life-like.

The popularity of these multimedia applications is fueled by the Internet, by which users can go “online” and “surf” a virtually infinite number of sites to experience and sample different multimedia offerings. One example of a popular feature available to users connected to the Internet is the ability to send friends, family members and colleagues electronic greetings and messages created or selected on a provider host site for downloading or communicating to other users via e-mail, electronic notification or other methods of delivery. Typically, such electronic greetings and/or messages are generally embodied in the form of an image or a brief animated feature chosen by the sender from a selection presented at the electronic greetings host site. Depending on the provider of the host site, users may be allowed to personalize each greeting by modifying the text message accompanying the selected content. The personalized greetings are then sent to the users' friends, family members or colleagues for holidays, special dates, keeping in touch, planning social or business functions, or for communicating any other desired message, similar to the manner in which traditional cards have been sent through personal exchange or through the regular mail system.

Presently, however, such electronic greetings host sites have not enabled publishers or users to exercise more creative control over the multimedia content such as by modifying sound, motion, visual and/or spoken dialogue of real characters appearing in the content of the prerecorded images or animated features.

Many of the services available to users via the Internet are provided to the users free of charge. Such services include the abilities to shop, to read the latest news from the website of a favorite newspaper or radio station, to check the weather forecast in any locality around the world, to obtain free comparison quotes for insurance, airfare, gift items, and more. To support the maintenance and operation of such websites or host sites offering free services to users, revenue is typically generated from sponsors who pay the host site providers to place advertisements for their products and services on the pages of the host sites.

To date, however, advertisements on the Internet and other wireless mediums have not been incorporated in a manner directly integrated into the content being viewed or heard by the users. Instead, such advertisements have been embodied as scrolling banner ads and hyperlinks placed around the peripheral regions of the content contained in the pages of the host site. Different strategies have been incorporated into such ads to attract users' attention and pique their interest. Examples of such strategies include scrolling or flashing text, rollover technology, changing images, and/or use of content designed to lure a user into “clicking” on the ad, such as a challenge to hit a moving target, solve a puzzle, a promise of prizes or compensation for “clicking” on the ad, etc.

Nevertheless, a user can easily ignore the ads by pulling the scroll bar down so that the banner ads disappear from the viewing window or simply by viewing only the substantive content of the web page while ignoring the peripheral regions of the page. Moreover, from an advertiser's perspective, once the advertiser submits the advertisement to a publisher or the like of the content displaying the ad, the advertiser forfeits control of the placement and context adjacent to which the ad will be placed. This may be undesirable to advertisers who wish to avoid having their products and services associated with certain objectionable or controversial subject matter.

One further problem with the prior art is that a potential author or creator of such communications might not be able to access the Internet with sufficient bandwidth capacity to allow the author to generate such communications. Furthermore, even if the author of the communication does have access to a higher bandwidth connection, it is possible that the recipient of such a communication does not have the bandwidth capacity to play or execute the communication once received from the author.

### SUMMARY OF THE INVENTION

In view of the foregoing considerations, the present invention addrsses each of the deficiencies noted in the prior art.

A first aspect of the present invention is to provide a media application service that enables producers, aggregators and distributors to efficiently and economically enhance the value of dynamic media assets by remotely serving, tracking and optimizing the placement of interactive and advertising elements in real time.

Another aspect of the present invention enables the creation of original and customized digital full-motion video, animated and static multimedia communications for delivery through a communication network or other electronic means.

In a preferred embodiment, the communications additionally contain advertisements, product placements, promotional leaders and trailers, promotional “jingles”, trademarked or branded words, phrasing, symbols or other branding or promotional properties as advertising.

Another aspect of the present invention provides a host site that builds upon the allure of on-line greeting cards by delivering full-motion, animated and static multimedia communications with powerful new features that provide for unprecedented personalization, expression and advertising opportunities.

A further aspect of the present invention provides a production platform via which a user can easily generate a customized template for creating original multimedia productions having individually customizable modules integrated in parallel or in series.

In an additional aspect of the present invention, unique, original, familiar and iconic content can be created and aggregated on the host site of the inventive system. Such content may include an interpretation or spoofing of recognizable moments from popular media, including movies, radio or television, using different actors, dialogue revisions and options conducive to communication delivery.

It is yet another aspect of the present invention to develop a new advertising medium by seamlessly integrating entertainment, information, message or other communication content with advertising content containing the promotional message(s) for the product or service being promoted.

A further aspect of the present invention provides a system having a host site accessible by users through a communication network to create customized and/or personalized digital electronic communications having both entertainment and/or personally relevant content and promotional value, using a variety of media to combine creative content from a variety of sources.

In yet another aspect of the present invention, user time on a host site is maximized by providing diverse features on the host site which cater to the various needs and interests of users.

An additional aspect of the present invention provides a system which allows a user to customize a digital multimedia communication for delivery to a recipient without requiring the user to have personal access to higher bandwidth network connectivity.

The present invention provides a digital multimedia application organization tool that accommodates any file format to enable producers, aggregators and distributors to control the presentation of dynamic media contents by weaving personalizing and advertising elements directly into or around any primary media content. Specifically, the invention provides an application-oriented service in which the presentation of a plurality of media items can be controlled remotely, by using a predefined script to designate the spatial and temporal placement of the plurality of media items.

Using the application framework of the present invention, content items containing advertising, marketing or other promotional content can be controlled to be executed in parallel and/or in series with content items containing entertainment, information, and message content, all of which may or may not be individually selectable and/or personalizable by an end-user. During playback or execution, the designated media items are delivered to a viewer or recipient in real time.

The present invention farther includes a system which provides advertisers with a superior system and method over the prior art to promote their products and services using rich media and VOD (video on demand) streaming technologies and in a user-interactive format, in which advertising content is integrally associated with expressive content selected by and personalizable by the user, and in which the advertiser has greater dynamic control over the placement and association of the advertised products or services. Such communications are henceforth called “advertainment” in the sense that they are personalized messages at the confluence of advertising and entertainment.

The present invention also includes a system which provides producers and other users an avenue different from and superior to those in the prior art to express themselves, and a method for implementing the system. In particular, the inventive system enables the producer or other users to create and deliver unique and customized communications by modifying existing or incorporating new text, sound, dialogue, motions, and/or visual content.

The present invention capitalizes on the confluence of three powerful concepts: demand for online communications, emerging higher bandwidth technologies and the opportunity to introduce advertising and branding in a highly relevant, measurable and accountable manner and format. Each of these concepts may be embodied either individually or in combination.

The inventive system includes a media channel that offers customizable communications and related features having flexible formats and diverse content to suit the purposes and personal tastes of all audiences. The media channel includes a host site user interface which provides a list, menu, or other means for a customer to select a type of communication, such as a birthday message, a holiday greeting, a personal expression, a business sales call, etc. Within each selection option, various further options may be presented for the communication to be embodied as a still image, an animated image sequence, a video segment, or an audio segment. For each of these options, a content field of captioned still shots or thumbnails is offered for the customer to preview and select as the basis for the communication. Additionally, each content selection may contain one or more marketing or advertising message(s) that is delivered as an integral component of the communication. In other words, the advertisement content is seamlessly embedded as an integral part of the content of each still shot or clip forming the basis for the communication.

The selected image, sequence or segment may be personalized by editing various aspects of its content within the host site. For example, the host site may provide users with the ability to add to or modify rich-media content by morphing audio and video content, blue screening, blending user uploads, combining two or more creative content selections provided by the host site, changing actors' dialogue and other elements as presented in the content selections, and to otherwise personalize elements of the communications as further described herein.

If the communication contains advertising, the entities sponsoring the product or services promoted in the communications can pre-establish and dynamically change their tolerances for editing the communications so as to limit or preclude modifications or deletions of content that would be inconsistent with or nullify the branding or promotional message the advertiser wishes to convey. Alternatively, sponsors or the system operators are able to remove branding or promotional information upon detection of a predetermined tolerance level of modifications inconsistent with the promotional message or inclusion of content deemed offensive or objectionable by the sponsor.

The finished, customized communication is stored at the host site provider or third party location (as in a private label communication) and can be forwarded to others in a number of ways. In one embodiment, the communication can be downloaded to the user's computer for personal enjoyment or can be communicated via e-mail to a recipient designated by the user. If the communication is to be sent to a recipient, the recipient receives an e-mail notification containing the distinct URL link to this communication at its storage location. The recipient can then click on the URL link using a mouse or other pointing device at the recipient's workstation, whereupon the communication may be played or executed by streaming video, for example. Once linked to the communication, the recipient optionally may be allowed to download the communication from a remote location at which the communication is stored, which may be through the host site or third-party location as mentioned above. Alternatively, the communication itself can be directly received by the recipient via e-mail as an attachment within the e-mail. Access to select, edit and create such communications and related features can be provided either as a free or paid service to the end-user sending the communication. In a preferred embodiment, operation of the host site is funded by revenue from the various entities sponsoring the advertisements embedded in the communications.

The media channel of the present invention provides advertisers with a highly relevant, directed, targeted and fully integrated advertising package that, unlike any other form of advertising, is selected by the audience for its intended audience. Using the system and method of the present invention, advertisers have the proactive ability to produce and tie their brands, products and services to specific messages, titles and categories selected by the users. Advertisers clearly value the ability to have individuals and business persons choose to share communications containing their advertising or marketing messages with friends, family and colleagues. Similarly, users will enjoy using this quick and easy-to-use system to communicate with friends, family and colleagues.

The present invention represents a new breed of advertising media made possible by higher bandwidth technologies and the demand by users for any form of media content, versus systems in the prior art using narrowband technologies and current advertising methods in which the entertainment content is separated from the promotional content and is beyond the control of the sponsor. In contrast, in the present invention, the media content serves as a communication vehicle for the promotional content. The communications created with the present invention thus have valuable utility to end-users in the form of entertainment, message or information or other communication and also to advertisers, sponsor, and other promoters by integrally delivering the promotional message with the communication content. This new advertising media, defined herein as “advertainment,” is therefore unique and different from all previously existing forms of advertisement and entertainment.

The present invention further provides an alternative system and method for creating and transmitting communications that typically require a higher bandwidth Internet connection. In one embodiment of the invention, an Internet kiosk with a higher bandwidth Internet connection is provided for the creation or authoring of multimedia personalized communications. Once the communication is created, it is burned into a CD-ROM or DVD in the kiosk and dispensed to the creator for shipment to a recipient via traditional delivery channels (e.g., U.S. Postal Service, Federal Express™, UPS™, etc) or by hand.

In an alternative embodiment, if the author has the bandwidth capacity on his or her workstation at the home or office, the present invention incorporates a writeable CD-ROM or DVD player on the workstation. Once the author has completed the creation of the communication, it is burned onto the DVD or CD player, and shipped to the recipient as described above. With this embodiment, the author may or may not be charged a fee for use of the service, in accordance with any arrangement between the author's and the service provider or the preference of the service provider.

Additionally, the present invention provides turnkey solutions and expert guidance to creative entities through the bewildering and torrid rate of technological change that has become common in recent years. For clients, agencies and freelance creatives, the clarity and comprehensiveness of the platform and business strategy offered by the present invention provide a palette of production management and authoring tools, all of which work for the majority of today's creative studios and Internet users. In addition, the present invention also includes a program that will provide technical guidelines and assistance to producers, directors and cinematographers interested in producing customized communications and multimedia productions optimized for variant bandwidth, software and hardware configurations.

### BRIEF DESCRIPTION OF THE DRAWINGS

Other features and advantages of the present invention will become apparent from the following description of the invention which refers to the accompanying drawings in which:

FIG. 1 is a schematic representation of the system of the present invention;

FIGS. 2A-2D are examples illustrating an editing process using meld technology;

FIGS. 3A-3B are examples illustrating an editing process using blue screening technology;

FIG. 4 is an example illustrating an editing process using morph technology;

FIG. 5 is a schematic illustration of a composition and playback sequence of multiple content segments arranged within a template according to the present invention;

FIG. 6 is a flowchart diagram illustrating the events for assembling a multilayered customized communication according to a script provided within the system of the present invention.

FIG. 7 is a flowchart which diagrammatically illustrates the method for customizing a communication using the system of the present invention;

FIG. 8 is a schematic illustration of the relationships between modular elements of an exemplary customized communication;

FIG. 9 is a flowchart diagrammatically illustrating the process for using the host site of the present invention;

FIG. 10 is an example of a compass tool for facilitating selection of a basic communication;

FIG. 11 illustrates a system and method for delivery of electronic communications; and

FIG. 12 depicts an alternative embodiment using an Internet kiosk for the creation of communications and optical disks containing the communication.

### DETAILED DESCRIPTION OF EMBODIMENTS OF THE INVENTION

The present invention includes a digital multimedia application platform and method by which accommodates or can be adapted to any file format to enable producers, aggregators and distributors to control the presentation of dynamic media contents by weaving any number of media content items directly into or around any primary media content. Specifically, the tool is applicable to any combination of digital and/or media types in which the presentation of the plurality of media items can be controlled remotely, by using a predefined script to designate the spatial and temporal placement of the plurality of media items.

Publishers, producers, distributors, etc. (collectively referred to hereafter as “publishers”) can create the predefined scripts or the scripts may be among the materials produced by the host site provider. Each script defines a shell having a number of modularized slots corresponding to the number of media items to be incorporated into the customized communication, and also designates properties such as spatial and temporal placement of each item relative to one another, length or duration of play of each item, etc. Using a selected script, publishers can control the arrangement of various types of media items relative to one another during playback or execution, and also which types of media items will be associated or incorporated into the arrangement.

Examples of media content items which may be incorporated into the application platform of the present invention include entertainment items, informational or communication content such as stock tickers, personal schedules, instant messaging, advertisement or other promotional content, to name just a few. Although the invention system and method can abe used with any combination of digital and/or multimedia content, the invention will be more fully described below in connection one specific type of application, specifically, the media channel of the present invention for delivering personalizable content which substantively incorporates or integrally associates advertising or marketing content therewith.

With the application platform of the present invention, content items containing advertising, marketing or other promotional content can be controlled to be executed in parallel and/or in series with content items containing entertainment, information, and message content, all of which may or may not be individually selectable and/or personalizable by an end-user. During playback or execution, the designated media items are delivered to a viewer or recipient in real time.

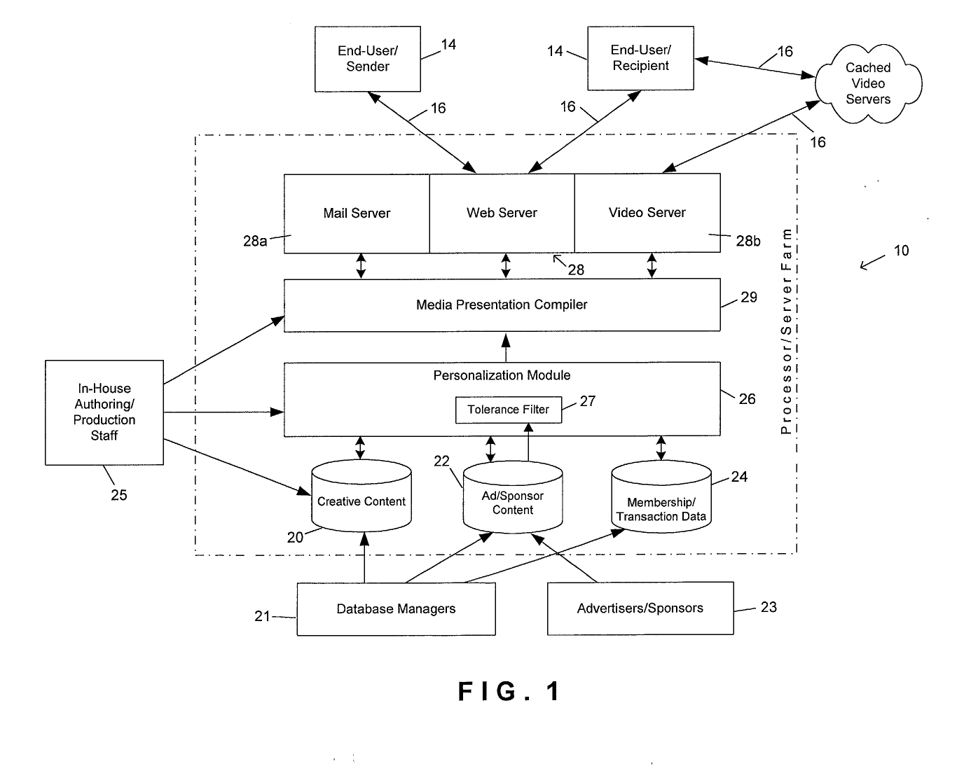

Referring now to FIG. 1, the system of the present invention is generally indicated as system 10. The system includes a media channel powered by the application platform of the invention, the media channel having a host site as a user interface and which is hosted at a processor or server farm 12 remotely accessible by a plurality of user terminals 14 via a communication network 16. Preferably, the communication network 16 is a global public communication network such as the Internet, but could be wireless or any other network.

User terminals 14 can each be any device capable of sending and receiving data across communication network 16, such as a personal computer, laptop computer, personal digital assistant or Internet access device such as WebTV™. Each user terminal 14 is preferably equipped with a user interface for accessing the communication network, for example, any standard web browser, such as Microsoft Internet Explorer®, Netscape Communicator® or the like for communicating on the Internet. Each user terminal 14 is also preferably equipped with a storage device for storing application programs and user data, a network interface for coupling user terminal 14 to communication network 16 and suitable display, input and audio reproduction devices.

The communication links connecting to network 16 can be any suitable communication link technology. Examples of such communication link technology include any wide area networking systems such as asynchronous transfer mode (ATM), digital subscriber line (DSL), frame relay, leased serial line, dial-up line, or local area networking technologies such as ethernet, token ring, WAP (wireless application protocol) and the like.

In a preferred arrangement of the present invention, the hardware requirements of the system are maintained at a third party facility (server farm) 12 while the proprietor of the system 18 manages and controls the system operation remotely from a separate dedicated location. The host site processor/server farm 12 can include any device capable of sending and receiving data across communication network 16, and which provides adequate firewall and security against unauthorized access of proprietary data and confidential user information. High speed parallel, redundant Unix®-based server farms, such as those provided by Verio® are preferably used for the host site processor/server farm 12 to provide high capacity and high-performance.

Regardless of the hardware, the host site processor/server farm 12 should be suitable to host a high-bandwidth web server 28, such as the high performance server by Apache®. A host site is stored in a memory in the host site processor/server farm 12 and is maintained and controlled by the host site provider or the proprietor of the system. The host site can be served to requesting members of the general public by the web server 28 through the various user terminals 14 connected to the communication network 16.

Web server 28 includes a mail server 28a and a video server 28b. Mail server 28a delivers notification to a recipient of a communication sent through the present system, and may also allow clients, users, etc. to set up individual or group email accounts in a manner similar to other mail servers known in the art.

Customized communications having time sequential properties such as video and/or audio segments are preferably delivered from a video server section 28b of web server 28 via the streaming technology services and FreeFlow systems provided by Akamai™. The Akamai™ architecture forms a cached array of intelligent hosts placed at key areas on the Internet and operates in tandem with the present system's web server to enable accelerated delivery of (streaming) media content to a user by placing a copy of a media file to be delivered to the user on a server geographically located as close to the user as possible. The FreeFlow system manages the traffic throughout the Akamai architecture by identifying the appropriate server to serve each delivery request. The delivery of media through the Akamai system thus provides the benefits of high performance buffering and latency to minimize dropped packets during delivery.

With the arrangement shown in FIG. 1, the system of the present invention is flexibly scalable and extensible for growth and added functionality as needed, while minimizing expenditures for hardware and support teams.

The host site serves as the interface through which users can utilize the system to create personalized communications according to the present invention. The host site uses a combination of HTML, CSS (cascading style sheets) and Flash technologies for content layout and user interactivity. Content is served dynamically through an intelligent XML-based template engine, which serves media types based on the current state of the creative content data, sponsorship data, user preferences and usage patterns. The host site's application layer logic is written using object-oriented techniques, which allow for a rich data abstraction, extensibility and reusability of code.

Personalization of communications is accomplished though a personalization software application module 26 hosted within processor 12. In a preferred embodiment, the personalization module 26 includes a multimedia workshop-type software program residing in the host site processor 12. The personalization module 26 allows publishers and users to personalize (customize) the electronic communications through various software techniques as will be described in more detail below, some as simple as text insertion up to more complicated methods such as melding or morphing. Additionally, the personalization module 26 receives requests from users, publishers and authors from their respective remote terminals; accesses creative content database 20, ad information and materials database 22, and membership and transaction database 24 (described below). Furthermore, personalization module 26 includes a tolerance filter 27 for setting editing tolerance ranges for each content item.

Media presentation compiler 29 compiles a customized communication according to predetermined sequencing and incorporating personalized content by the end-user according to the application platform described above, and generates a unique link to each personalized media segment and finished customized communication.

Host site processor 12 further includes or is coupled to a creative content database 20 containing the basic communication content selectable by a user and a database 22 for storing users' customized communications and/or user channels set up by users to save their preferences. Optionally, the processor 12 may be connected to an advertisement database 24 containing promotional features to be combined with elements from the creative content database 20 to form the basic communications to be customized by users. User preference and transaction information stored in database 22 may also serve as a marketing database, which may be useful to advertisers to more accurately tailor the promotional content directed to targeted audiences.

Although the processor or server farm 12 at which the databases 20, 22, and 24 are located may be provided and maintained by a party other than the proprietor of the present invention, each of the databases are readily accessible and maintained by the appropriate database managers 21 to oversee database schema, object templates, non-programmer user interfaces, generate reports, etc. For example, the assets and data contained in databases 20, 22 and 24 are managed and controlled remotely by the host site provider 21. Content in the advertisement database 24 and the creative content database 20 may be directly or indirectly accessed by the advertising entities partnered with the proprietor of the system to change or update the contents thereof as necessary.

The database 20 is further accessible by in-house and/or outsourced staff 25 to update the creative content occupying the database. Personalization module 26 may serve all production staff, publishers and end users in editing, updating, and personalizing the media content material from the databases 20 and 22. The proprietor of the system and publishers, and optionally end-users, also have access to define the media application scripts used in the presentation compiler 29 for assembling the customized communication according to the invention.

Creative content database 20 is a collection of stock art including a variety of images, animated and live-action video sequences, audio segments, textual phrases, and proper nouns including popular names. The data in database 20 is stored in compressed format and tagged with arbitrary and related category information so that users can browse, preview and search the creative content, and also send the creative content as may be incorporated in a customized communication.

The creative content selections contain unique, original, familiar and iconic content that may include an interpretation or spoofing of recognizable moments from any media, including movies, radio or television, with different actors, dialogue revisions and other options conducive to communication delivery. For example, selectable content for creating communications may be acquired by licensing from ancillary sources such as JoeCartoon™, Atom Films™, Ifilm™, Toma™, Honkworm™, Like-Television™, Pop.com, ACTV.com and similar sources. Other content may include portions of new and old catalogue movies, television shows, radio programs, advertisers, other Internet sites, music and other media clips, leaders, trailers and promotions, and award programs overseas obtained through sources such as media studios, archives, stock houses, various rights owners and rights clearance expediters.

Additional creative content may be originally produced by the operator of the host site and third parties, or may be acquired from other sources or methods which have been developed or used by the host site operator. Original content owned by the proprietor of the host site could be produced, for example, as photographed images or short film or audio clips of various scenes and scenarios performed by actors and actresses contracted for by the host site operator. Also, creative content may be added later on by a user to be merged with content provided by the host site, or to form the basis itself of a creative multimedia communication.

Optionally, the creative content presented for selection to the user may include promotional messages sponsored by commercial entities desiring to promote their respective products and services through the system of the present invention. Such promotional messages may be embedded in or integrally associated with each textual selection, image, video or video/audio segment, so that a selection by the user of a basic communication automatically includes a selection of the embedded advertisements.

In a preferred embodiment, each of the images or segments which may be selected as the theme for a communication includes, as an integral aspect of the creative content selection, advertising content for a product or service. Such advertising content may be embodied in the form of product placement, promotional leaders and trailers, musical promotional branding “jingles”, trademarked or branded words, phrasing, symbols, Flash vector animation, HTML linked images, or other advertising and marketing vehicles, either implicit or explicit.

Alternatively, different promotional messages and images can be stored in database 18 separately from the basic creative content stored in database 20. In this case, upon selection of a basic content, the user is then required to select from a displayed list of promotional materials suitable for the selected basic content. The selection materials here are in the form of images, text, audio, etc. which may be naturally associated with the selected basic content, and which would be appealing to the user to enhance the selected basic content. For example, a user may select a video clip of a tropical island setting from the stock content in the host site which may or may not already include sponsor placement or association. Thereafter, the user is required to select another content item to be incorporated into the tropical island setting, such as an image of a cruise ship bearing the name of a sponsoring cruise line or an image of a beach towel with a bottle of suntan lotion of a particular brand name lying next to or on the towel.

The data contained in advertisement database 18 can be collected using any of a number of techniques. In one aspect, the promotional data can be directly provided by the respective advertising entities. This can be accomplished by any known file transfer technique including the file transfer protocol (FTP) either directly into the database or via processor 12. Alternatively, advertisement content may be loaded into the database from a storage medium such as a CD-ROM, DVD-ROM, floppy disk, etc., or via a modem, satellite reception, or other remote link.

Regardless of the source of the communication content, each of the video, audio, and multimedia selections is relatively short in duration, preferably under 90 seconds and commonly under 60 seconds, as opposed to the longer “short-film” durations, so as to cater to Internet users' trends and habits. Of course, longer clips may be provided or created depending on the user's purpose for the communication or the effect desired to be achieved thereby.

To the extent that any of the creative content selected by a user for creating a communication contain identifiable patent, trademark and copyright proprietary features and technologies belonging to third parties not associated with the host site provider, the use of such features and technologies is in-licensed when necessary for use in connection with creating communications within the host site, and in connection with use of any of the other features provided in the host site.

To maintain a high level of interest and desirability of the system contents in the eyes of potential users as compared with current and future on-line and off-line communication services, the host site is updated on a periodic basis to include new offerings having content which reflects current events and popular culture. To this end, the depth and breadth of communications and features available on the host site are continually enhanced in order to provide users and advertising partners with the most appealing forms of communication and advertising, respectively.

A significant feature of the present system is that it allows end-users to modify their communications through a variety of customization methods, including: multiple-choice or open-choice written and audio text replacement or alteration of scripted dialogue rewritten directly into the content; phone-in audio text alterations to replace some or all of the pre-scripted dialogue's nouns, verbs, adjectives, adverbs, pronouns or proverbs; on-site pre-recorded audio alterations; text, dialogue or audio sent as an attachment file via e-mail; mail-in or fax-in audio; typed or handwritten text replacements, e.g. signatures; multi-lingual dubbing. Once in hand, the system of the present invention is capable of digitally combining such user-provided audio and visual content with the original communication in a manner and using various technologies such as those discussed below.

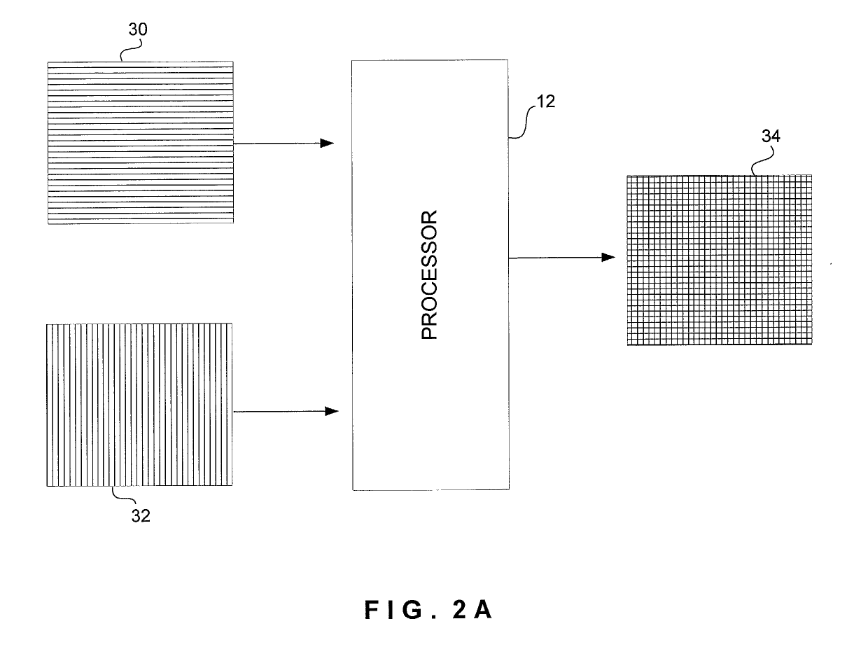

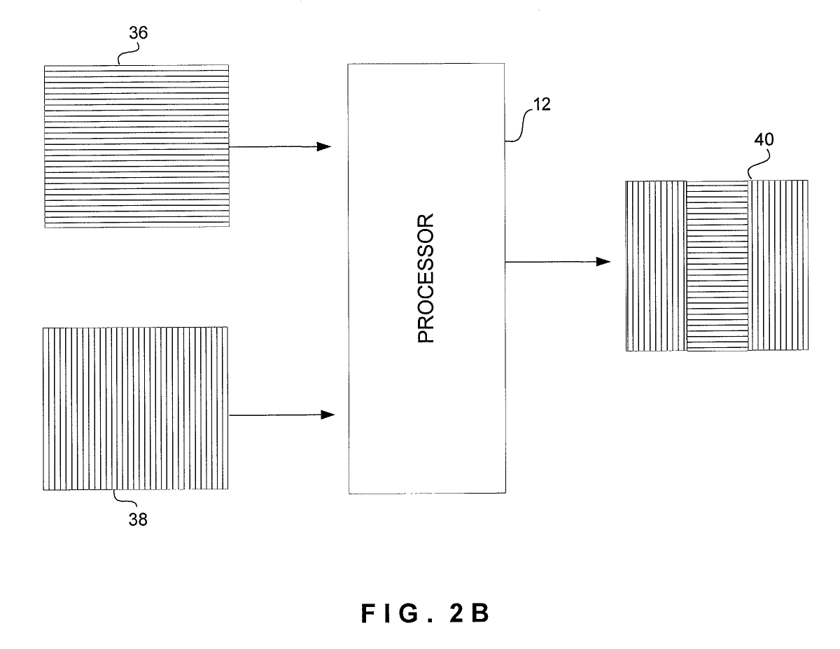

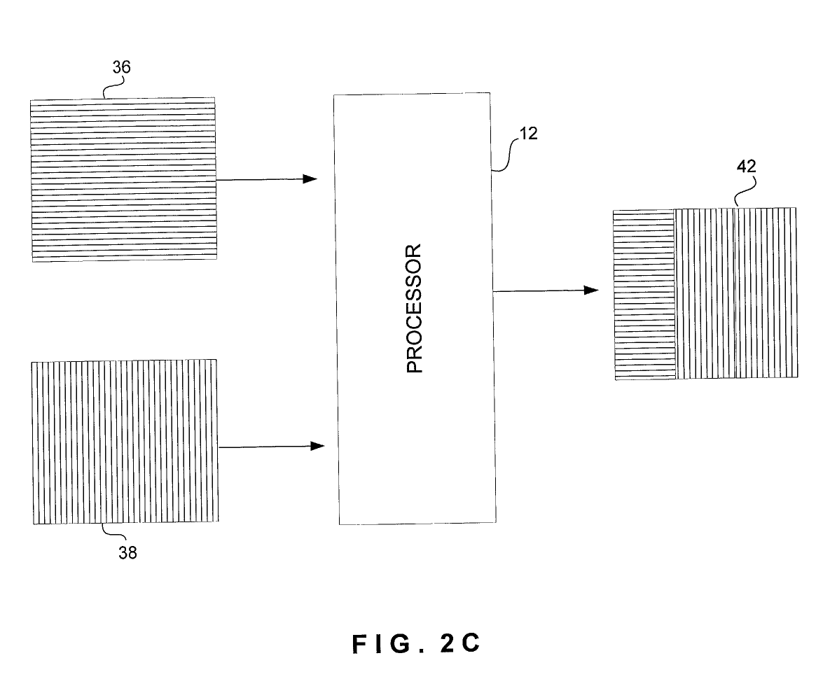

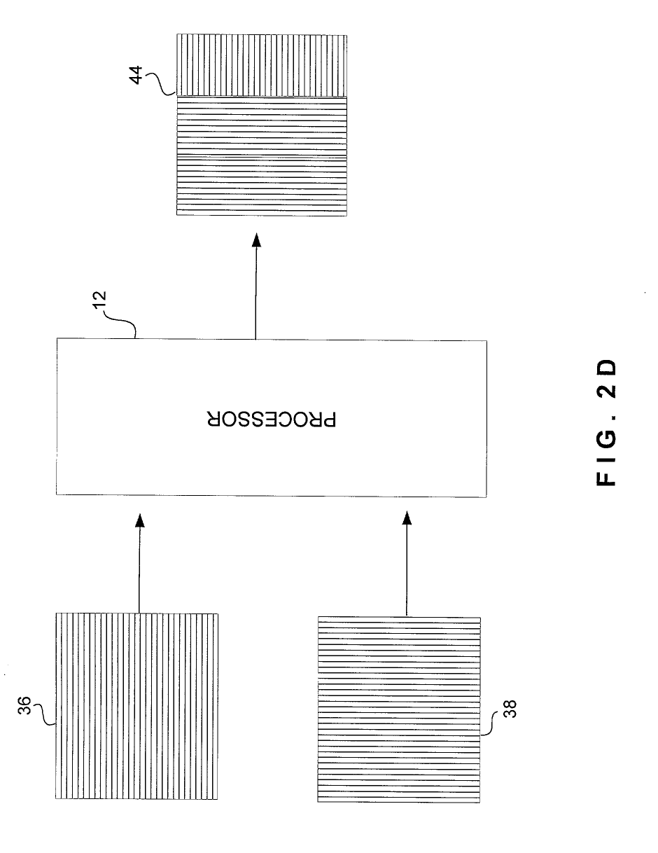

One example of an editing process used to form a customized communication is melding. Melding is a digital transformation process which seamlessly integrates changes into its surrounding features. Available tools for performing a melding operation include RealNetworks™, Windows® Media, and Quicktime® application packages, and other media applications collectively known as “media players.” Using this process, new images can be superimposed on the original image and blended into the surrounding objects and background so as to appear as if the new image was part of the original. For example, in FIG. 2A, pattern 30 and pattern 32 are inputted to the processor 12. Although the processor characterized in FIGS. 2-4 are indicated as being the same as processor 12 of FIG. 1, it is readily appreciated that the editing techniques of the present invention may be implemented by a separate processor or processors. Processor 12 superimposes pattern 30 onto pattern 32 to yield new pattern 34. Similarly, a background image can be filled in and/or reshaped to reflect the removal or addition of an object or shape.

Referring to FIGS. 2B-2D in regard to further melding examples, patterns 36 and 38 are inputted into processor 12. Depending on the effect desired by the user, the two patterns are seamlessly spliced together to yield pattern 40, 42, or 44. Using meld technology, therefore, user-provided communications, content and submissions may be mixed with host site and third party communications, content and features to produce personalized communications that combine the desired aspects of each component.

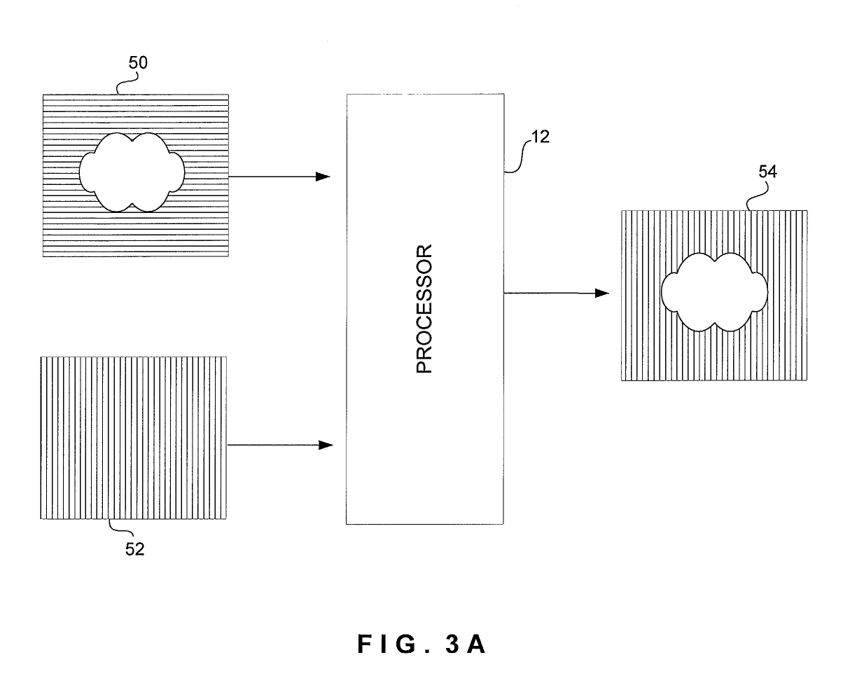

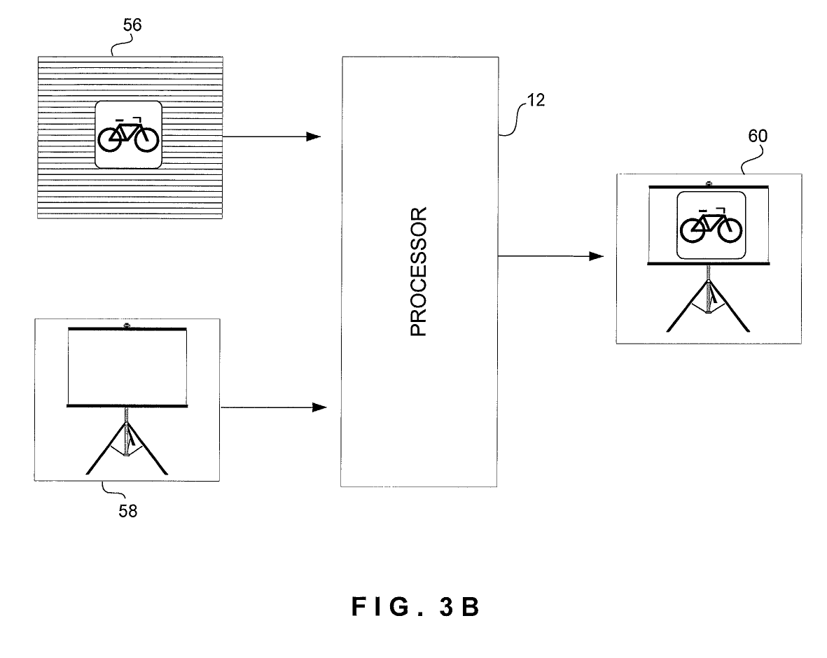

Another method for customizing users' communications content is a process known in the art as bluescreening, which enables the placement of images, including the user's own, into a creative communication with celebrities or to provide a background without the subject actually being where it appears, or into otherwise desirable image settings. The concept of bluescreening is disclosed, for example, in U.S. Pat. No. 5,543,856 to Rosser et al. Using bluescreening technology, the illusion is created that the image or other subject is physically placed in the depicted setting when in actuality no such placement exists. As shown in FIG. 3A, the image 50 and background 52 are inputted into processor 12, whereupon the composite image 54 is outputted in which the image 50 is projected onto the background 52. Similarly, FIG. 3B shows the simultaneous projection of both of images 56 and 58 onto a blank background to generate the image 60 outputted from processor 12.

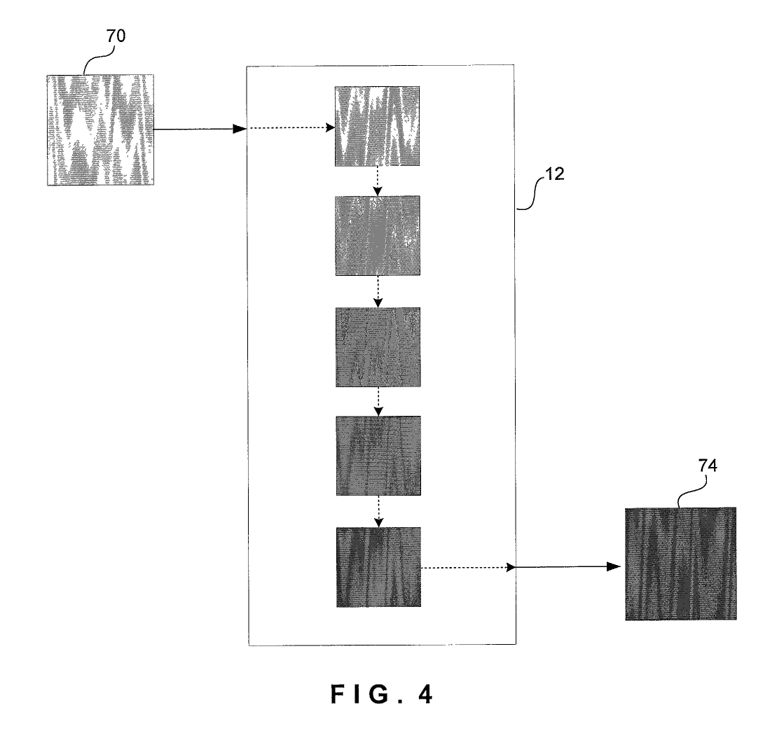

Morphing is another type of digital transformation process in which an image can be incrementally and progressively changed into another image. Like melding, any of the media player application packages mentioned previously may be used to achieve the desired morphing effects. Using a series of intermediate target images, sequences of original movements or sounds in a sequence may be altered by incrementally changing the movements or rebuilding the sound sequence as desired by the user. An example of morphing is demonstrated with reference to FIG. 4, in which an image 70 is inputted into processor 12. Using appropriate editing tools such as the aforementioned application packages, the image 70 is gradually transformed into the image 74.

In a preferred embodiment, morph technology is used to achieve synchronization of actors' mouth movements and voiced phrases to produce personalized communications that could incorporate limited choice or infinitely variable communications through sequential readings of words, names, and sounds by actors during production. By smoothly effecting image and dialogue variations in this manner, users and advertisers are enabled to script, filly or in part, highly personalized communications in English and other languages. Such powerful editing capability provides users with unprecedented flexibility, interaction and control in personalizing communications created within the host site.

The melding and morphing techniques described above can be executed by the user directly, beforehand by the system operator, or editorial and/or production staff to provide “stock” images or clips for selection by users, or in real time by the system in response to commands by the user.

As discussed previously, in addition to allowing the end-user to edit content files to produce communications personalized to the user, the present invention also enables the host site provider, advertisers, licensees, and/or the end-user to incorporate the personalized or non-personalized content selected or provided through the host site into a multi-linear communication package which affords authors with increased flexibility in production formats.

Any desired combination of media segments can be assembled sequentially and/or simultaneously in modular fashion to create a composite customized communication. In other words, not only are end-users enabled to directly edit a segment of creative content using one of the processes described above, but publishers and advertisers sponsoring the media channel for the benefit of end-users can also create expanded multimedia productions to incorporate multiple instances of personalized and/or non-personalized media segments into multi-linear playback sequences based upon the author's preferences and the properties of the media data.

The ability to control the arrangement and context of the personalized or primary media content is based on a modular design which an accommodate any media technology platform and feature set, and requires no special applications or downloads for licensees or end-users (other than the standard media player capabilities). Such application platform enables the customized communication to be assembled on demand according to the selections of an end-user and delivers the compiled sequences for playback or execution in real-time.

For assembly using the modular design of the invention, each individual selection of media content, both personalized and non-personalized, is categorized according to the type of media and whether or not it has a timeline element. As discussed above, each content item may be an image, text, a video sequence and/or an audio segment. Among these media content types, each content item can be categorized as being either static or dynamic data.

Text and image data, such as a JPEG, GIF or bitmap file, are examples of static data. A static content item can have a time property associated with it. For example, to display a logo during a video playback, a textual phrase or logo image (.jpg or .bmp) is displayed over time, unchanged. Its default time property, however, is zero.

On the other hand, a dynamic content item, by default, has a time property association. Audio or video content are dynamic data which, by nature, have a time property associated therewith. Such dynamic content, however, may have additional elements associating a timeline element. For example, a video sequence is composed of a series of frames, or static views, of the dynamic sequence, with each frame being different from adjacent frames. To achieve “movement” throughout the video sequence, each static frame is displayed for a specified length of time before progressing to the next frame. The default time property for the video sequence may be calculated as the number of frames multiplied by the frame rate (the time each frame is displayed), which yields the length of the media content.

Each content item also has additional properties, including micro and macro relationships. A micro relationship is defined as behavior within the content item itself, such as its timeline duration. A macro relationship is defined relative to other content items. For example, an audio segment could be made to loop for the entire duration of a series of video segments, like background music. In this case, the duration of the audio segment would be set to the desired sequence length, which would be greater than the length of the audio segment itself.

Using these principles, a selected collection of media items are assembled to form a customized communication using a variety of editing tools to seamlessly combine the items in the desired arrangement in parallel and/or in series. To achieve the desired arrangement, the user selects or formulates a template or script according to which the media items are to be assembled during the playback sequence. It is important to note that unlike with the editing tools described above where the content itself is actually changed by the editing process, the individual segments here need not be changed so as to be combined with any other items. Rather, the combined or integrated effect of the items during playback is due to the simultaneous and/or sequential execution of the designated items.

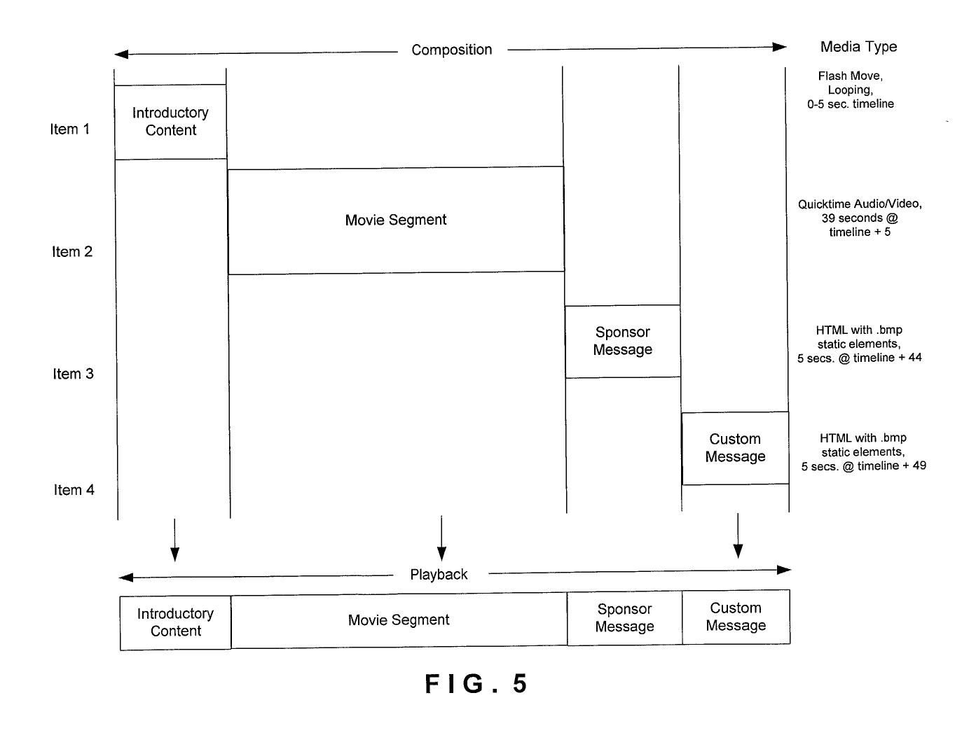

For example, a preferred script is shown in FIG. 5 in which a personalized video sequence is incorporated into a template having four layers such that execution of the video sequence is temporally preceded by an introductory content item, such as another video sequence, a static image display, a Macromedia Flash™ segment, etc. A third layer contains a sponsor message to be executed subsequently to the video sequence. Another customized media content item, i.e. a custom message, constitutes a fourth layer which is designated to execute temporally upon completion of sponsor message. The duration and arrangement of each layer of content can be predetermined in the host site system or can be set by the user.

Preferably, the introductory media content displays information about the proprietor of the present system. The sponsor message may include advertising content and/or further information about the proprietor or its products, and may or may not be personalizable using the techniques described above. Alternatively, the sponsor message may be dedicated to an advertiser which may or may not be associated with any end-user selected content incorporated into the communication script, or to a private label contracting through the proprietor of the present invention.

The templates serve as pointers to respective media items of designated categories so that a number of customized communication productions have the same basic structure and playback sequence, but different content items as appropriate in each finished communication. Using this feature, an author (including advertisers, licensees and end-users) would be able to easily produce a plurality of customized communications, each one specifically tailored to an individual recipient. An event planner would be able to create a number of invitations to various events (sponsored by several different organizations) using the same overall format but only providing each recipient with information relevant to the specific event to which that individual is being invited.

The length of time each static item is displayed or the duration of looping of a video or audio segment is set as a parameter within the script. Similarly, the transition between sequentially arranged items may be predetermined as part of the script. For example, a content item may be designed to fade away into the next item using “sprite” tracks or other digital transition elements inserted at the appropriate timing with the script.

In a variation of this aspect of the invention, after displaying the sponsor screen for the predetermined length of time, the viewer may be presented with selectable options to play the customized communication, to view another page providing additional information about the sponsor or host site, to send a reply, and/or other information and options. If an option other than playing the message content of the communication is selected, the playback sequence then leaves the scripted sequence to execute the selected request, which may or may not be part of another sequence script.

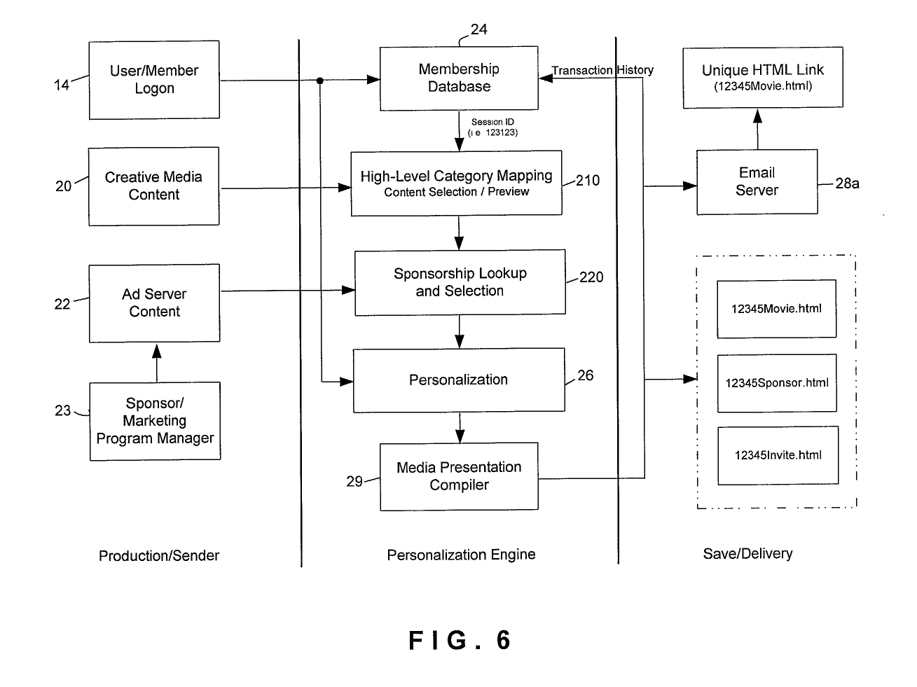

FIG. 6 shows a diagram illustrating a typical process for producing a sequenced customized communication according to the present invention. First, a user accesses the host site, wherein the user may or may not be registered with the host site, and selects and/or personalizes a rich-media content according to the methods described above. Each time a user enters the host site and personalizes a selected rich-media content, and/or sends a customized communication, the system assigns a session ID number to the user session. Furthermore, the user's preferences and transactions are recorded in the membership database 24.

Each item of multimedia content in the system is cataloged with markers to indicate the type of media and subject matter category to facilitate selection and preview by users, advertisers, and publishers, and to facilitate sequencing in assembling multi-linear communications (high-level mapping module 210). For each media item selected by a user to be incorporated into a customized communication, the system automatically determines or selects sponsorship information to be associated or embedded with the selected content using the sponsorship lookup and selection module 220. The user may then choose to personalize the selected content item(s) using the personalization module 26.

Here, the system also determines whether or not any editing of the selected content by an end-user has rendered the content inconsistent, offensive, or otherwise objectionable to the determined sponsor. The tolerance criteria may be determined by the sponsors themselves or by marketing program managers 23 accessing the ad server database 22. If so, module 26 alternatively prevents the content from being edited in the objectionable manner, selects another sponsor which may be compatible with the personalized content, or removes any branding or sponsorship association from the personalized content. For example, if a user attempted to remove a product logo from a selected image or attempted to change the text or dialogue contained in a video segment to be repugnant to the sponsor message, the system filters would prevent that particular editing attempt from being completed. Alternatively, the system could allow the content to be edited in the manner desired by the user, and simply remove any sponsorship association from the content, for example by removing a label or logo, or by deactivating an affected “hotspot” in an image. Such advertiser-defined tolerances may be enforced by establishing certain zones or intervals in the images or segments which are write-protected, and/or by using filters to evaluate the content to block out objectionable subject matter.

In this example, personalization of the selected content includes a custom message to be displayed separately from the selected video segment, i.e. an invitation to a private event. Upon saving the content item(s) to be sent to a recipient, media presentation compiler 29 assembles a customized communication based on an appropriate script in accordance with the media application platform of the present invention. Specifically, media presentation compiler generates a number of indexed files for assembly according to a script predetermined by a sponsor or publisher. Preferably, the script is formulated by the advertiser associated with the media content selected by the user, but may also be a default script designated by publishers or the host site provider.

Upon saving the personalized communication, an identifier is associated with the content by the script relative to the user database, such as the session identifier number—in this example, 123123. Based on this identifier, the following 3 files are created: 123123Movie.html for the selected video segment, 123123Sponsor.html for the sponsor message associated with the selected content, and 123123invite.html for the custom invitation message. Each of these three files is created from existing templates on the host site. In one example of a template, a sequence is comprised of a QuickTime movie, followed by a five second sponsor screen, and ending with a custom greeting/message. When played in the media application viewer, these three media segments seamlessly combine into one linear experience. Each page, Movie.html, Sponsor.html and Invite.html, are sequenced via META tags for refresh according to the script, so that each page loads the next, by name, after a given event or time period.

Using the sequenced META tagged files according to the script, the email server 28a generates a unique HTML link to be sent to the recipient. The receiver(s) of this customized communication will receive an email greeting containing the generated hyperlink. If the receiver(s) desires to send a customized communication back to the sender, the process described above repeats.

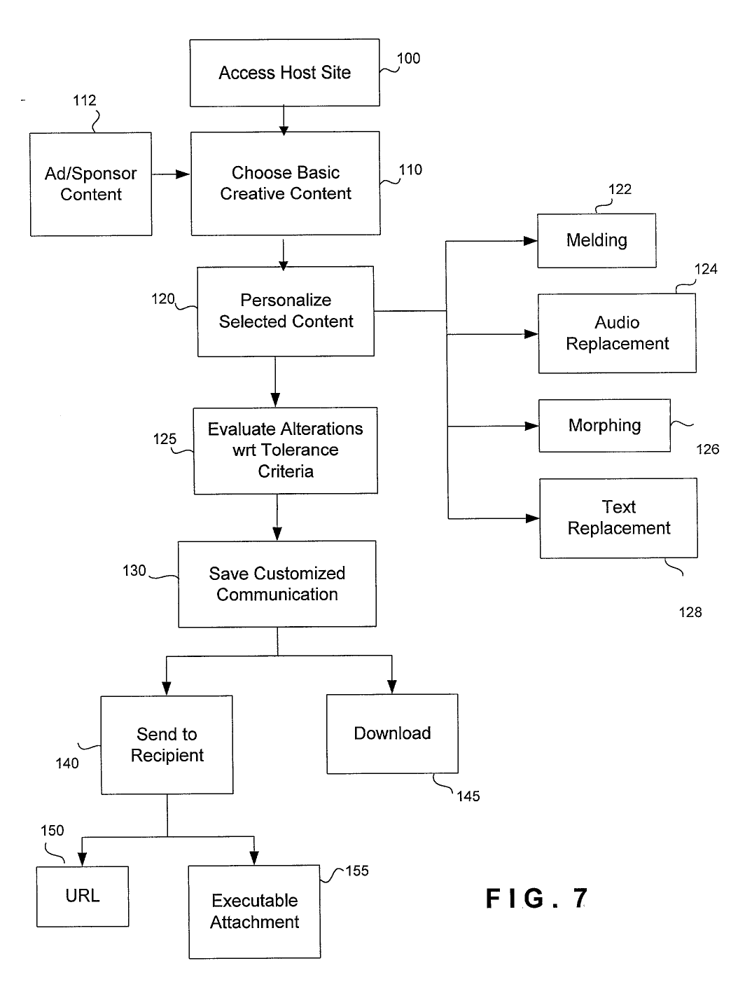

Another example for creating and sending a customized communication incorporating all of the features of the invention will now be described with reference to FIG. 7.

First, the user accesses the host site over a communication network, preferably the Internet, through a browser interface provided at a user terminal 14 (FIG. 1) or any other suitable type of connection hardware (e.g. PDA, satellite system, etc.), as indicated in step 100. As previously discussed, the user is then presented with a wide variety of media items, including images, video, video/audio and audio items representing a variety of themes. The user can browse, preview or search among the available items to aid in his or her selection of content in step 110. The available items and images may be organized for the user's selection in various manners, as will be discussed further below. Upon selection of a basic content item, the user is enabled to select from among further options to either send the selected item or to personalize the content thereof.

Assume the user selects a content having a Valentine's Day theme and then selects the option to personalize the selection. More particularly, the user selects a video/audio clip showing a couple having a conversation over dinner at a new restaurant in town. In this example, the selected basic communication contains advertising content in the form of the name of the restaurant being displayed as a logo on a mirror on a wall behind the couple's table. In this example, the user also chooses a dialogue sub-option within the selected video segment discussing a particular vacation resort while sitting at their table. Upon selection of the resort-themed dialogue, a poster appears on the wall of the restaurant displaying the name and a picture of the vacation resort. Additionally the user further decides to enhance the romantic atmosphere of the setting by placing a vase containing a beautiful flower arrangement on the couple's table, whereby the vase plus flower arrangement is associated with a flower delivery service as a sponsor.

In step 120, the user personalizes the video segment by scanning in a photograph of himself and his girlfriend, whereby his image and the image of his girlfriend are melded into the video in place of the original characters (step 122). Next, the user selects his girlfriend's name from a list of on-site pre-recorded clips of spoken audio to be inserted at the appropriate location(s) in the conversation between the couple in the communication (step 124). Then, using morph technology, the mouths of the characters are edited so that the mouth movements correspond with the newly inserted words as they are spoken (step 126). At the end of the video segment, the user melds in a trailer segment to display a text phrase typed in at the user's workstation according to an open text replacement feature (step 128). For example, the user may enter the phrase, “Happy Valentine's Day, I love you” followed by his girlfriend's name, along with an additional personal message.

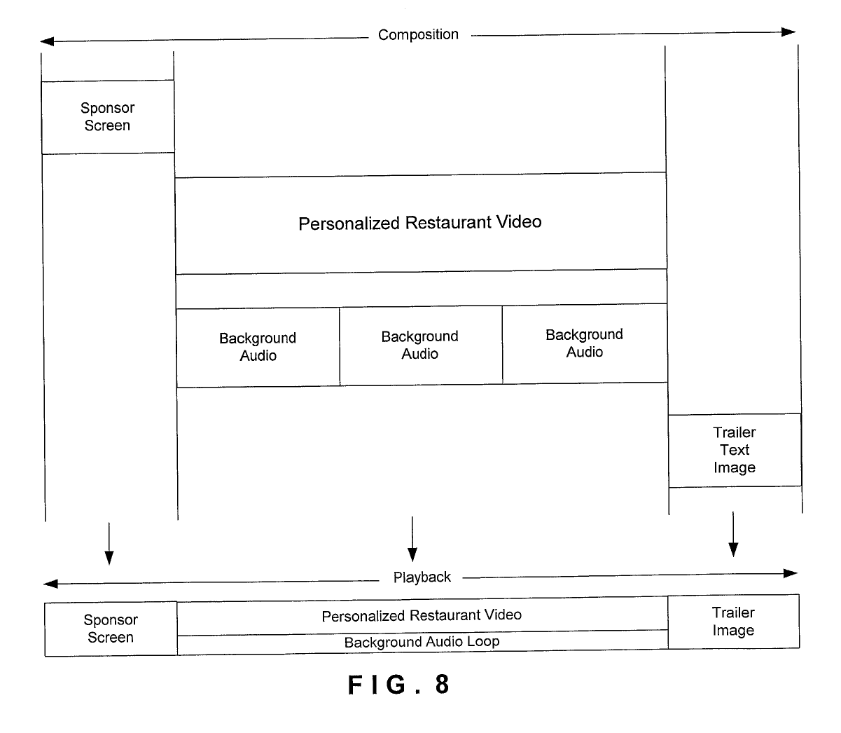

As a finishing touch, a repeating loop of either soft music or perhaps background “restaurant-type” noise may be selected to be played for the duration of the communication sequence. The temporal relationships between each of the media segments is illustrated in FIG. 8.

Each editing change made by the user is evaluated at step 129 to ensure that the changes do not fall outside the sponsors' pre-established tolerances. In this example, the user would have been precluded from removing the poster or the restaurant logo on the wall. Also, the user would generally be prevented from inserting vulgar language, for example, into the conversation. As mentioned previously, the system could alternatively allow the user to edit the content as desired, even in a manner objectionable to the sponsor, but then the sponsor information would be removed, such as by changing the poster on the wall to a generic poster or removing it entirely.

At any time during the creation or personalization of the communication, the user may be enabled to preview the communication including the most recent changes. Preferably, the host site will also enable the user to “undo” up to a predetermined number of the most recent changes. Also, the host site is arranged to provide the user with access to every navigation alternative at all times.

When the customized communication is completed to the user's satisfaction, the method then proceeds to step 130, wherein the user saves the personalized communication in the host site, which is compiled and assembled into the finished customized product according to a predetermined script in the manner discussed above. At optional step 145, the user can download a copy of the completed communication to his own computer. More significantly, however, the user sends an e-mail to his girlfriend to deliver the communication (step 140). Preferably, the e-mail is sent from within the host site. Additionally, it is preferred that the e-mail sent to the recipient contains a URL directly linked to the communication (step 150) at the host site.

After assembling the composite communication according to the template, the communication is delivered to the user's girlfriend via email as mentioned above. Upon receiving the e-mail, the recipient “clicks” on the hyperlinked URL, whereupon the host site is accessed on the web browser at the recipient's terminal, and the customized communication is executed in real time via streaming media delivery. Alternatively, instead of receiving a URL, the e-mail sent to the recipient can include an executable attachment of the communication itself (step 155) to the email, whereupon execution of the communication is effected after loading a temp copy of the entire file to the recipient's location.

To complete this example, upon opening or accessing the customized communication, after viewing the sponsor screen for the predetermined length of time, the user's girlfriend would see a sponsor screen providing information about the host site displayed for the predetermined length of time, whereupon the image then fades into the scene of herself and her boyfriend at a table in a restaurant, with the name of the restaurant displayed in the background. Soft music as may be realistically heard in a live restaurant would begin playing softly in the background as the couple begins a brief conversation about an upcoming vacation to a certain resort, as may be appropriate for the Valentine's Day theme. The image of the flowers in the vase on the table may blink or flash occasionally to indicate to the view that it is an active site. If the recipient were to roll the mouse (or other pointing device) at her user station so that the cursor is positioned anywhere over the vase or flowers, a pop-up microsite containing promotional information for FTD® flowers or an icon of the FTD® would appear. If desired, the communication recipient could then “click” on any designated link in the microsite to learn more information about FTD®'s products and services. In another embodiment, if the product placement is “active”, meaning it is placed in the communication by an advertiser, the host site may notify the user that they have won a promotional gift or received other consideration in connection with interacting with the communication.

Communications created according to the present invention thus constitute a new advertising medium in which elements of the communications which cater to the demand for entertaining rich-media content have certain advertising content embedded therein to create what may be collectively referred to as “advertainment”. One advantage of the present inventio is that advertisers are enabled to control the context, substance and placement of its promotional message while catering to the dynamic interests of the viewing audience, as opposed to the prior art where control of advertisement content is relinquished to media publishers who then collate the advertisement messages according to their own operations.

The advertisements embedded within the communication content generate income for the operator of the host site through strategic product placements that encourage users to identify the promoted products within the communication. Once identified, a click of the user's mouse when the cursor is positioned on the promoted products might deliver one or more of the following to the user: contest entry, discount coupons, gift certificates, hyperspace adventures, free products and services, purchasing opportunities, educational opportunities, links to sponsor's site, or other promotional and/or informational consideration. For example, in a communication that incorporates product placements, the user can identify and “click” on products that appear in the communication.

Income from sponsoring entities can also be collected via sale of advertising time and space and sale of traditional advertising banners and hot links. Moreover, database tracking of product recognition and marketing, and user behavioral and transactional database marketing are also viable methods for collecting fees from sponsoring entities, as discussed more fully below.

The host site of the present invention incorporates the capability to monetize its traffic through database marketing and e-commerce activities. Through user registration and additional information collected in connection with e-commerce and promotional programs, the present invention is a highly effective method of capturing valuable and marketable user identification, behavioral and transactional data.

Additionally, the system has the ability to leverage and compile demographic and psychographic data (obtained primarily via click-stream) from user interaction with the host site to offer a meaningful value proposition to its advertising, promotional, sponsorship and e-commerce partners and clients. In other words, user profiles are preferably established for repeat visitors by recognizing and storing information about the features, communication content, advertising links, etc. selected or “clicked on” by each user. Captured user profile information and information relating to a user's behavior patterns and preferences obtained in this manner are stored in the database 22 shown in FIG. 1. The more a user interacts with the host site, and the more times a user returns to the host site, the more data can be gathered about the user. The collected information can then be used to target future advertisements, features and contents towards users' tastes and inclinations, and to provide feedback to advertisers regarding their offerings.

The number of users who view the communication and the number of users who participate in promotions such as “click-to-win” contests on product placements presented within the communication content can also be directly accounted for. Furthermore, for each promotional feature in a communication, the host site is equipped to keep track of the number of times users interact with the communication to acknowledge the promotional feature. This information may also be stored in database 24 of FIG. 1.

Such powerful dynamics enable the system to specifically target mass audiences, as well as to influence the on-line and off-line behavior of its users, and allow for attractive, relevant, and targeted marketing opportunities. The data collected from the accounting methods described above may also be used to correlate the amount of revenue received from the individual sponsors paid to the host site owner.

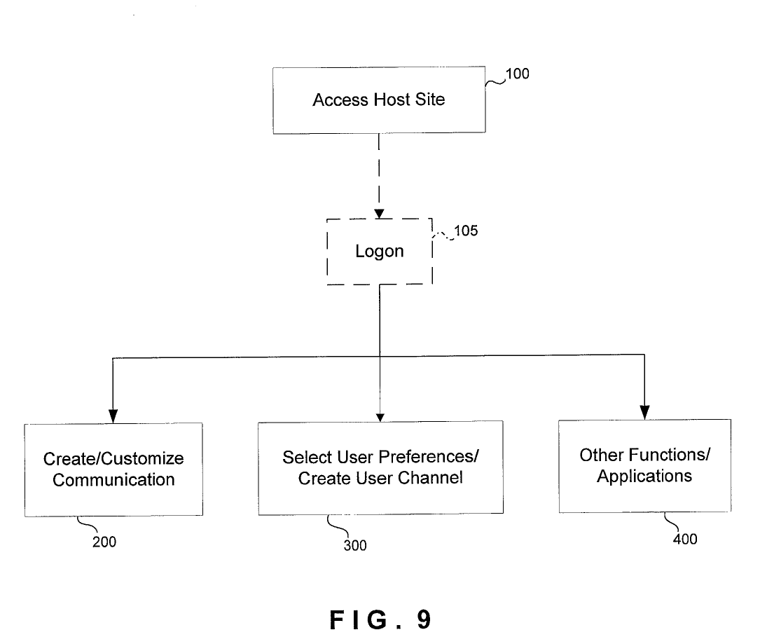

A method for using the host site of the present invention will now be described with reference to the flowchart shown in FIG. 9. In step 100, a user accesses the host site from a terminal or computer 14 (FIG. 1) remote from the host server 12 of the present invention. Upon accessing the host site, the home page of the host site is displayed on the user's display device. Although not required, the user may be presented in the home page with the option of establishing a login account with the host site, logging in to an established account, or logging in as a guest user, at step 105. Preferably, the home page of the host site present system attracts new users and encourages users to establish individual accounts by displaying information or links to information describing the objectives and capabilities of the system, along with a selective sampling of communications which can be created through the host site, as well as of other popular features which may be available through the site, as will be discussed more fully herein.

Once the user has logged in with the host site at step 105, either as a registered user or as a guest, the user may begin using any of the features or applications provided on the host site (step 400), or may begin the process of creating a personalized communication as described above (step 200). To facilitate this selection process, the content and features of the host site are preferably organized into channels (“communication channels”) and selectable via a pull-down menu or a list of hyperlinks. Examples of the many types of categories in which the communications may be organized include age, generation, nationality, language, gender, ethnicity, special occasions, events, holidays, art, comedy, sexuality, relationships, Webcam™/voyeur, special interest groups, travel, technology, geography, mime cards, virtual pets, public address, kids, religion, sports, celebrities, “yes man,” “lucky 8-ball,” poetry, music, visual arts, dance, nature, humor/spoofs, talent show, amateur hour, sound-alikes, look-alikes, and other appropriate communication channels.

Preferably, users are quickly and proficiently directed to the appropriate or desired communication channels via a choice from a plurality of host site channels organized with the aid of a decision tree tool, such as a hierarchical menu of occasions and events. Alternatively, the user can narrow the option field with a meta search engine that searches the host site or the web for communications or features which match the term(s) entered by the user. In another variation of the host site, the user can choose an emotional or professional avatar to guide the user's selections from among the options available through the host site.

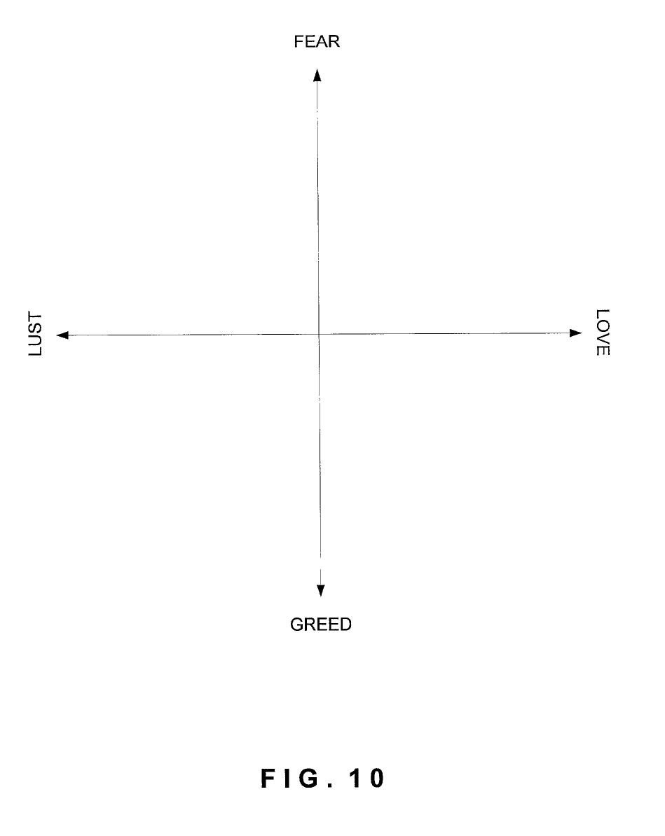

In an alternative embodiment for facilitating channel selection provides a “compass” tool. As an example of the “compass” tool, FIG. 10 shows a grid divided into quadrants by two axes which delineate fear and greed on the vertical, and love and lust on the horizontal. Instead of fear/greed and love/lust, other emotions may be chosen as the endpoints for the grid To use the “compass” tool, a user quantitatively evaluates the emotion to be reflected in the communication, application or feature desired to be created or used according to the extremes defining the boundaries of the grid, and places a marker on the grid according to the evaluation by “clicking” at the appropriate location with the user's computer mouse. The host site will then display a list of appropriate channels. This feature reduces the size of the lists that the user must sort through in the selection process and provides the user with a focused list of selection options more closely aligned with his or her interests or intent.

A still further variation for channel selection includes a “mood ring” tool, such as a spectral band of colors representing different feelings or emotions. Operation of the “mood ring” tool is similar to the “compass” tool, in which the user identifies a color along the spectrum best representative of the mood desired to be expressed in the user's ultimate selection.

The content of the host site is dynamically served through an intelligent XML-based template engine whereby the layout may be reorganized from a default or new user arrangement based on updated and/or information acquired from the user's prior interactions on the site. In this manner, the present system encourages repeat visits to the host site by allowing registered users to customize the host site interface to display the content, features, and services preferred by the user (step 300). The user's settings, preferences and usage patterns are stored in database 22 in FIG. 1. Once the user has set his or her preferences (directly or indirectly), each time the user logs in to the system thereafter, the host site welcomes the returning visitor with the pre-established settings. The customization capability not only allows users to set preferences for choosing, creating, editing and sending communications, but also enables placement of other specialty features on the personalized site, such as calendars, reminders, previous works created on the host site, templates, news, sports updates, stock prices and other features.

Also at step 300, users can establish unique addresses, or “user channels,” within the host site to produce and save their personal or entity communications and other content, which may include up-loaded digital videos, music and other programming and production, personalized communications and other content as work in progress for re-use at a future date. Preferably, the user channel data is stored in the database 24 as shown in FIG. 1. The user channels can additionally be used to exhibit the user's previous or ongoing projects by incorporating technologies enabling multiple recipients to directly access and view the user's work (narrowcast), or by posting the user's work on public or limited access bulletin boards controlled by the host site (broadcast). In narrowcasting a user channel, the user loads into the host site a personal address list so that the user can easily send a particular communication to multiple recipients or enable those designated persons or entities to access the user's channel. On the other hand, providing access to a user's channel on the host site's bulletin board allows access to any user of the host site to view the contents of that channel.

As previously indicated, the features of the present invention are not limited to the creation of customized advertainment communications. To maximize the value of the present system to users so as to encourage their use thereof, the host site serves as a media engine that provides a number of additional capabilities and functions which may be desirable to users. Referring back to FIG. 7, selection of any of these additional functions and applications, as will be discussed below, corresponds to step 400.

For example, creative images, either as originally provided on the host site or as edited by a user, may be captured into a screensaver and placed in active residency in the user's workstation. Alternatively, the host site may provide “prepackaged” screensaver designs containing either new content or content taken from the images and clips used for creating communications. Similarly, a user can place a perpetual link to a favorite communication developed on the host site on the “desktop” of the user's computer display terminal, possibly through an evergreen link to the host sites.

The host site further includes interactive functions engaging a plurality of users simultaneously logged in to the host site, such as bulletin boards, chat rooms, instant messaging, real-time multi-user communication and content development, and interactive games with promotional gifts and rewards. Other community features available to users on the host site include buddy lists for instant messaging or for distribution of creative communications, contests for creative use of the services offered by the present invention, streaming in music and other audio and visual content to a user's computer or terminal while the user is logged in to the host site, etc.

Additional features may be developed within the context of the present invention, including communication crossword puzzles, memory games (where users uncover multimedia clip by matching clues), horoscopes, calendars, reminder services, personal ads/loveline services, etc.

The system of the present invention is flexibly designed to cater to many different types of audiences, from school-aged children to business professionals. Thus, in addition to the categories of creative content previously listed herein, the host site provides commercially oriented features which are targeted to businesses as well as individuals. The diversity of content and features in the present invention enable users to create multiple-use communications with a variety of media uses, including entertainment, communication of information and messages, advertising, Advertainment, presentations, invitations, solicitations, condolences and any other dimension of personal or entity communication.

The present system may also provide adult communications, to be accessed either on a separate host site or through a link or section of the main host site. In either case, access to the adult content is secured by credit card requirements and/or other preventative measures against under-age user visitation. Such content may include concepts such as click-to-strip, sexual avatars, suggestive bikini and babewatch photos, images or video clips, and other similar features for the adult-only audience.

Business and commercial applications may be provided on a contractual or out-licensed basis, perhaps an intranet rather than through the publicly accessible Internet. Under this type of arrangement, company messaging and addressing and other distributions may be distributed to corporate employees or specified segments thereof via the discrete, closed-circuit network within the corporate entity. Examples of customizable content directed to the business audience include features such as stock analyses, video resumes, appreciation or recognition rewards, management functions or events, user relations, inspirational messages from senior management, recruiting, and messages intended for targeted industries (banking, brokerage, IT, etc.), vendors, secretaries, assistants, superiors, laterals, etc.

The system and method of the present invention additionally provides, either in conjunction with the host site or as a separate benefit offered by the invention, technical guidelines and assistance to producers, directors and cinematographers interested in producing media content optimized for the bandwidth and hardware capabilities of the system.

Through user interaction with the promotional features contained in communications created with the present invention, additional revenue may be generated from any electronic commerce transactions launched from a communication or elsewhere in the host site. Such commerce revenue may be generated via transactions such as indirect sales of video and other movie media, compact discs and other music media, books, art, toys and other merchandise; event tickets, auctions, points and rewards, lotteries, and payment processing; sale of merchandise bearing content proprietary to the host site, including t-shirts, mugs, videos, music, mousepads, trading cards, and comics; and other e-commerce activities as the host site may undertake.

Alternatively, or in combination with profit-seeking arrangements, revenue generated from the host site may be allocated for public service by enabling charitable giving in the name of other users and Internet users.

If selected interfaces and features within the host site are provided to users free of charge, the host site can offer users the opportunity to upgrade to, or participate in, other premium services or features provided within the host site, such as those to be discussed later, either on a subscription basis or on a per use basis.

Other sources of revenue for the host site include fees for reunion and meeting planning, party admissions, previews of guest or donor lists, and other features as may be provided by the host site. Along this vein, it is envisioned that invitees to the event would each receive a communication custom designed through the system of the present invention. Such invitational communications may or may not include advertising content, and may instead contain links, flashes, or hot spots providing relevant information concerning the event.

An additional source of revenue may be generated from the invention by enabling users to create and store a personalized communication onto a portable storage media either through licensed or purchased software usable at a user's personal workstation, or by charging users a nominal retail fee at stand-alone kiosks placed at convenient public locations to create personalized communications and stored onto the portable storage media.

Off-host site revenue may be generated from various licensing opportunities through the distribution of communications, sponsored micro-sites and areas, referral fees on prospecting cards, private label communications (such as the event planning concept described above) with embedded or explicit advertainment, production of host site magazine, TV show, radio shows, communication compilations and other media to be sold to other industries or the public.

Out-licensing opportunities may be created by publication of user submissions on the host site, whereby the user can gain publicity for his or her work, and may share revenue with the host site, thus promoting user development of communications and content.

Recognition and publicity for the present system may be gained through various strategies, such as through user referrals. For example, a viral marketing community may be generated by sharing revenues or equity with independent submissions. Other methods for promoting the present system include sharing of lottery and other probability-based prize winnings and promotions with “cooperative participants” who refer at least one new user to the host site, thus providing incentives to respond to invitations or sign up for membership, and encouraging the development of serial communications, story lines and games that may have multiple endings.

Outside of the host site, public familiarity for the system may be fostered by enlisting ad agencies as marketing arms with whom host sites can barter for advertising campaign and buying opportunities, and enlisting host site and communication sponsors, including higher bandwidth, video, and MP3 providers, other web sites and popular brands and products. Mutual benefit between the present system and third parties may be developed by licensing communications produced within the host site to portals and other businesses seeking increased volume of consumer and business traffic.

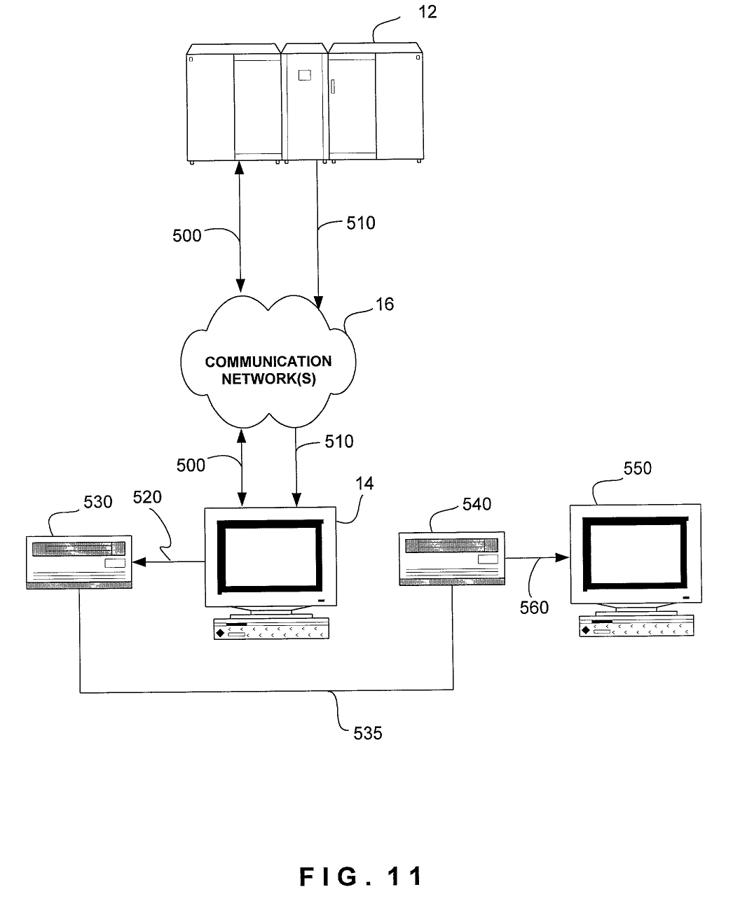

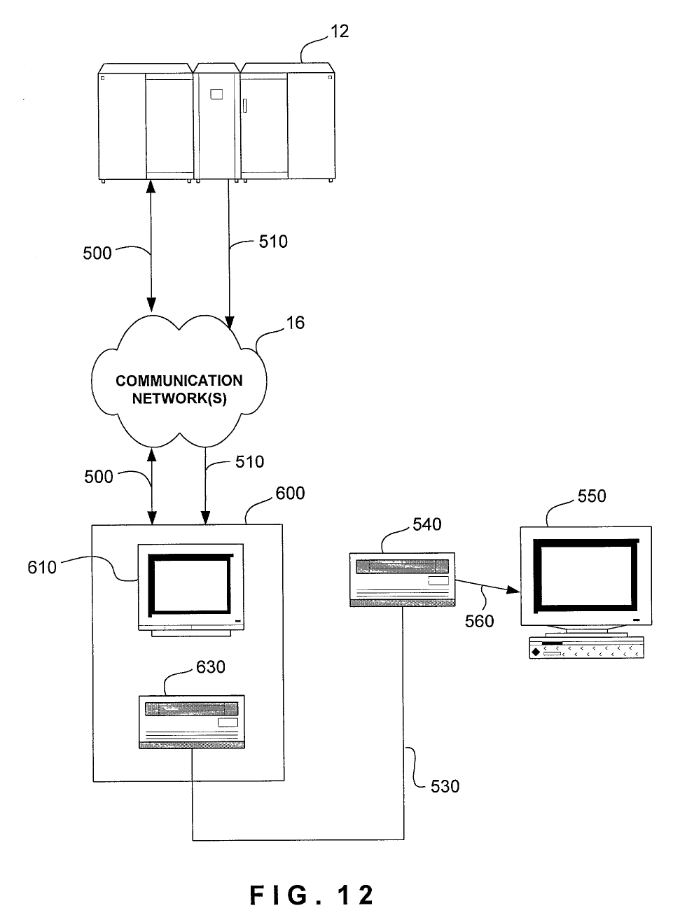

FIGS. 11 and 12 illustrate alternatives of the system and method of the present invention for the creation and delivery of customized electronic communications. As previously described with respect to FIG. 1, the authoring portion of the present invention includes multimedia workshop type software program residing on an Internet website maintained and controlled on a server 12 by the proprietor of the system. The website can be accessed and utilized by members of the general public through the Internet 16 using a personal computer 14 or other type personal workstation (e.g., Personal Digital Assistant (PDA), cellular phone, etc.). Users are able to utilize the multimedia workshop type software program by accessing the host site of the inventive system using a higher bandwidth connection between the user's workstation 14 and the Internet 16. The host site 120 serves as the interface through which users can utilize the system to create personalized communications according to the present invention.

Once the user has completed the creation process (step 500) with respect to his or her communication, the communication is downloaded from the host server 12 (step 510) through the Internet 16 to the user's workstation 14. At that point, the user directs its workstation 14 to download the communication to the optical drive 530 (step 520). Optical drive 530 is a read/write drive that can either be a CR-ROM drive or a DVD drive. Alternatively, the optical drive 530 can be a Write Once Read Many (WORM) drive. As optical disks (CD-ROM or DVD) have ample storage, a short communication as contemplated by the present invention is easily burned onto such a disk.

Once the disk has been created containing the communication, the user is able to ship the disk (step 535) using conventional delivery means such as the U.S. Postal Service, Federal Express™, UPS™, etc. Upon receipt, the recipient of the disk is able to load it into his or her optical drive 540 and play the communication (step 560) on his or her workstation 550. As previously described, the system and method of the present invention is particularly attractive for recipients whose workstation 550 does not have sufficient bandwidth capacity to view the communication directly on the website server 12 of the host. In an alternative embodiment, the recipient does not even have to have a workstation if the optical drive 540 is a home DVD player that is coupled to the recipient's television (not shown).

In another alternative embodiment, a user is able to connect to the host site server 12 using an Internet kiosk 600 as illustrated in FIG. 11B. The kiosk 600 includes a monitor 610, input devices (not shown) such as a keyboard, mouse or trackball, an optical drive 630, a higher bandwidth connection to the Internet 16, and a means for collecting payment from the user (not shown). The operation of the system of FIG. 11B is the same as described above with respect to the system of FIG. 11A except that the user uses the kiosk 600 to create the communication and bum the optical disk. Kiosks 600 can be installed anywhere where a higher bandwidth connection can be established and maintained such as in a card store, a mall, or a supermarket.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A system for creating multimedia electronic communications, the system comprising:
a network interface to a communication network through which a user can access the system;
a host processor coupled to the network interface, the host processor operable to create the multimedia electronic communications based on at least one creative content item; and
a creative content database coupled to the host processor, the creative content database containing a plurality of creative content items,
wherein each creative content item includes media content selectable by the user and advertisement content, such that the advertisement content is embedded as an integral feature of the selected media content or is integrally associated with the respective creative content item.

2. The system according to claim 1, further comprising an advertisement content database coupled to the host processor, the advertisement database containing a plurality of advertisement content items corresponding to a respective creative content item such that upon selection of media content from the creative content database by a user, the corresponding advertisement content is integrated with the respective creative content item.

3. The system according to claim 1, wherein the media content in each creative content item includes at least one of a static image, digital video, animated video, live action video, text, and audio.

4. The system according to claim 1, wherein the media content is less than or equal to 90 seconds in duration.

5. The system according to claim 4, wherein the media content is less than 60 seconds in duration.

6. The system according to claim 1, wherein the media content includes content from at least one of motion pictures and television shows.

7. The system according to claim 1, wherein the media content includes satirical interpretations of content from at least one of motion pictures and television shows.

8. The system according to claim 1, wherein at least one of the media content and the advertisement content includes original content produced by an operator of the system or for the operator of the system.

9. The system according to claim 1, wherein the advertisement content is integrated into the media content by product placement.

10. The system according to claim 8, wherein the product placement is accomplished through one of a leader segment, a trailer segment, an audio jingle, and trademarked or branded text or graphics appearing in the media content.

11. The system according to claim 1, wherein the host processor is operable to allow the user to preview the media content prior to selection thereof.

12. The system according to claim 1, wherein the plurality of creative content units in the creative content database is organized by categories or themes.

13. The system according to claim 1, wherein the host processor is operable to search the creative content database according to search criteria inputted by the user.

14. The system according to claim 1, further comprising a user database which stores creative communications previously created by the user.

15. The system according to claim 14, wherein the host processor is operable to allow the user to controllably provide a selected group of other users with access to the user's previously created communications stored in the user database.

16. The system according to claim 14, wherein the user database also stores information regarding user preferences and behavior collected from the user's transactions with the system.

17. The system according to claim 1, wherein the host processor is operable to deliver the creative communication to a recipient via a URL contained in an e-mail, wherein the URL links the recipient to the storage location of the creative communication for execution thereof.

18. The system according to claim 1, wherein the host processor is operable to deliver the creative communication to a recipient as an executable program attached to an e-mail.

19. The system according to claim 1, further comprising a workstation computer coupled to the network interface, wherein the creative communication can be downloaded to the workstation computer from the network interface.

20. The system according to claim 1, wherein the advertisement content contained in a creative communication is interactive.

21. The system according to claim 1, wherein the advertisement content contains a link to a remote network destination providing additional information about a sponsor or its products.

22. The system according to claim 1, further comprising:
a personalization module coupled to the host processor, the personalization module allowing the user to personalize at least one of the media content and the advertisement content in a creative content item.

23. The system according to claim 22, wherein the personalization module is operable to integrate both static and dynamic content into the media content.

24. The system according to claim 22, wherein the personalization module is operable to integrate user-provided images, text, sound, and/or motions into the media content.

25. The system according to claim 22, wherein the personalization module is operable to integrate two or more creative content items.

26. The system according to claim 22, wherein the personalization module enables the user to modify both static and dynamic aspects of the media content.

27. The system according to claim 22, wherein the personalization module is operable to modify a creative content item by multiple choice or open choice text replacement.

28. The system according to claim 22, wherein the personalization module is operable to modify a creative content item by alteration of audio dialogue in the creative communication.

29. The system according to claim 22, wherein the personalization module is operable to modify a creative content item by a melding process.

30. The system according to claim 29, wherein the melding process incorporates changes to an image in the media content.

31. The system according to claim 22, wherein the personalization module is operable to modify a creative content item by a bluescreening process.

32. The system according to claim 22, wherein the personalization module is operable to modify a creative content item by a morphing process.

33. The system according to claim 22, further comprising an electronic filter having predetermined tolerance criteria and operable to prevent the user from altering a creative content item in a manner prohibited by the tolerance criteria.

34. The system according to claim 22, further comprising an electronic filter having predetermined tolerance criteria and operable to remove the advertisement content upon determination that the creative content item has been altered in a manner prohibited by the tolerance criteria.

35. The system according to claim 22, further comprising an electronic filter having predetermined tolerance criteria and operable to remove association of the advertisement content from the entertainment content information upon determination that the creative content item has been altered in a manner prohibited by the tolerance criteria.

36. A multimedia electronic communication comprising:
media content containing both video and audio components; and
advertisement content which is substantively embedded as an integral aspect of the media content.

37. A publicly accessible kiosk for creating multimedia electronic communications, the kiosk comprising:
a host processor operable to create the multimedia electronic communications using at least one creative content item; and
a creative content database coupled to the host processor, the creative content database containing media content selectable by a user, wherein the media content contains both video and audio components.

38. The kiosk of claim 37, further comprising:
a local processor housed in the kiosk; and
a network interface coupled to the local processor, the network interface providing an interface to the Internet, wherein the host processor and the creative communication database are at a location remote from the kiosk, whereby the local processor can communicate with the host processor though the Internet.

39. The kiosk of claim 37, wherein the electronic communications are deliverable to recipients via the Internet.

40. The kiosk of claim 37, further comprising:
a recording device housed in the kiosk and coupled to the host processor, wherein the recording device is operable to record a multimedia electronic communication on a portable storage media.

41. The kiosk of claim 40, wherein the portable storage media is an optical disk.

42. A system for producing media package on demand for delivery in real-time, comprising:
a plurality of media items each accessible from a data source according to a unique identifier;
a multi-linear sequencing script designating a plurality of modularized sequence slots for indicating a temporal and spatial arrangement of each of the plurality of media items relative to each other during playback of the media package;
a sequence compiler for assembling a media package according to the multi-linear sequencing script.

43. The system according to claim 42, wherein the sequence compiler assembles the media package by using associating each of the modularized sequence slots with a respective pointer to indicate the media item to be executed at each slot.

44. The system according to claim 42, wherein each slot has a temporal property for designating a duration of execution of a media item to be executed in the slot.

45. The system according to claim 42, wherein the modularized sequencing script enable a first media item to be executed in series with a second media item.

46. The system according to claim 45, wherein the sequence compiler is operable to execute a first media item in series with a second media item and to insert a sprite track or other digital element in transition between the first and second media items during playback.

47. The system according to claim 42, wherein the modularized sequencing script enable a first media item to be executed in parallel with a second media item.

48. The system according to claim 47, wherein the modularized sequencing script further enables a third media item to be executed in series with at least one of the first media item and the second media item.

49. The system according to claim 42, further comprising a cached multi-media server for streaming delivering the media package for playback in real-time.

50. The system according to claim 42, wherein the assembled media package can be created on demand by a user in which the user selects at least one media item to be incorporated into the media package.

51. The system according to claim 42, wherein the sequence compiler is operable to incorporate both static and dynamic media items into the multi-linear sequencing script.

52. The system according to claim 51, comprising a first dynamic media item having a first duration time and a second dynamic media item having a second duration time shorter than the first duration time, and wherein the sequence compiler is operable to repeatedly loop execution of the second media item in parallel with the duration of the first media item during playback to temporally fill a modularized slot designating the second media item.

53. The system according to claim 51, comprising a static media item and a dynamic media item having a duration time, and the sequence compiler is operable to hold a display time of the static media item in parallel with the duration time of execution of the dynamic media item during playback in accordance with the multi-linear sequencing script.

54. The system for creating multimedia electronic communications according to claim 42, further comprising:
a network interface to a communication network through which a user can access the system;
a host processor coupled to the network interface, the host processor operable to create the multimedia electronic communications based on at least one media item;
a creative content database coupled to the host processor, the creative content database containing a plurality of creative media items; and
a sponsorship content database coupled to the host processor, the sponsorship content database containing a plurality of sponsorship media items,
wherein each creative media item includes media content selectable by the user and is integrally associated with at least one sponsorship media item, such that selection of a creative media item by the user automatically results in selection of the associated sponsorship media item, and
wherein the sequence compiler incorporates the selected creative media item and associated sponsorship media item into a multimedia electronic communication to generate a playback sequence according to the multi-linear sequencing script.

55. A method for creating multimedia electronic communications, comprising:
producing a creative content database coupled to a host processor, the creative content database containing a plurality of creative content items, wherein each creative content item includes media content selectable by a user;
forming an advertisement content database coupled to the host processor, the advertisement database containing a plurality of advertisement content items corresponding to a respective creative content item;
providing a host site interface to enable a user to connect to the host processor through a communication network; and
upon selection of a creative content item by a user, integrating the corresponding advertisement content with the media content of the selected creative content item to form a basis for a multimedia electronic communication, such that the advertisement content is embedded as a substantive feature of the media content information.

56. The method according to claim 55, wherein the step of producing a creative content database includes creating original content by an operator of the host site.

57. The method according to claim 55, wherein the step of producing a creative content database includes creating original content by a third party for an operator of the host site.

58. The method according to claim 57, wherein the step of producing a creative content database includes creating original content by a licensee of the operator of the host site.

59. The method according to claim 55, wherein the step of producing a creative content database includes obtaining a stock selection of proprietary materials owned by third parties not associated with the host site.

60. The method according to claim 55, wherein the advertisement content is integrated into the media content by product placement.

61. The method according to claim 60, wherein the product placement is accomplished through one of a leader segment, a trailer segment, an audio jingle, and trademarked or branded text or graphics appearing in the media content.

62. The method according to claim 55, wherein the step of producing the creative content database includes organizing the plurality of creative content items into categories and/or themes to facilitate searching and preview by users.

63. The method according to claim 55, further comprising collecting and storing information regarding user preferences and behavior data based on users' transactions through the host site.

64. The method according to claim 55, further comprising storing multimedia electronic communications created by users based on the selected integrated media and advertisement content items.

65. The method according to claim 64, further comprising delivering to a recipient a multimedia electronic communication via a URL link contained in an e-mail, wherein the multimedia electronic communication is based on an integrated media and advertisement content item selected by a user, and wherein the URL links the recipient to the storage location of the multimedia electronic communication for execution thereof.

66. The method according to claim 64, further comprising delivering to a recipient a multimedia electronic communication as an executable attachment to an e-mail, wherein the multimedia electronic communication is based on an integrated media and advertisement content item selected by a user.

67. The method according to claim 64, wherein the stored multimedia electronic communications can be downloaded to a user's workstation computer from the host site storage location through the communication network.

68. The method according to claim 55, wherein the advertisement content contains a link to a remote network destination providing additional information about a sponsor or its products.

69. The method according to claim 55, further comprising enabling a user to personalize the media content of a selected creative content item.

70. The method according to claim 69, further comprising, for each advertisement content item, setting predetermined tolerance criteria to prevent the user from altering a creative content item in a manner prohibited by the tolerance criteria.

71. The method according to claim 69, further comprising, for each advertisement content item, setting predetermined tolerance criteria to remove the corresponding advertisement content from the media content of a selected creative content item upon a determination that the creative content item has been altered by a user in a manner prohibited by the tolerance criteria.

72. The method according to claim 69, further comprising, for each advertisement content item, setting predetermined tolerance criteria to prevent or remove association of the corresponding advertisement content from the entertainment content information of a selected creative content item upon a determination that the creative content item has been altered in a manner prohibited by the tolerance criteria.

73. The method according to claim 69, wherein the user is enabled to personalize the selected creative content item by integrating both static and dynamic content into the media content.

74. The method according to claim 73, wherein the user is enabled to personalize the selected creative content item by integrating user-provided images, text, sound, and/or motions into the media content.

75. The method according to claim 69, wherein the user is enabled to personalize the selected creative content item by modifying both static and dynamic aspects of the media content in the selected creative content item.

76. The method according to claim 75, wherein the user is enabled to modify the selected creative content item by a melding process.

77. The method according to claim 75, wherein the user is enabled to modify the selected creative content item by a bluescreening process.

78. The method according to claim 75 wherein the user is enabled to modify the selected creative content item by a morphing process.

79. The method according to claim 55 further comprising recording onto a portable storage media a user created multimedia electronic communication based on an integrated media and corresponding advertisement content item selected by the user.

80. A method for creating multimedia electronic communications, comprising:
producing a creative content database coupled to a host processor, the creative content database containing a plurality of creative content items, wherein each creative content item includes media content selectable by a user;
forming an advertisement content database coupled to the host processor, the advertisement database containing a plurality of advertisement content items corresponding to a respective creative content item;
providing a host site interface to enable a user to connect to the host processor through a communication network;
upon selection of a creative content item by a user, integrally associating the corresponding advertisement content with the media content of the selected creative content item; and
compiling a playback sequence containing at least the creative content item and the associated advertisement content arranged to be executed in parallel and/or in series according to a predetermined script so as to produce a multimedia electronic communication.

81. The method according to claim 80, wherein compiling the playback sequence comprises arranging the at least the creative content item and the associated advertisement content in modular format.

82. The method according to claim 80, wherein the compiled playback sequence is executable in real-time during playback.

83. The method according to claim 80, wherein compiling the playback sequence comprises generating a series of pointers designating a respective content item for playback at an appropriate timing according to the predetermined script.

84. The method according to claim 80, wherein compiling the playback sequence comprises incorporating both static and dynamic content items into the scripted playback sequence.

85. The method according to claim 80, wherein compiling the playback sequence comprises incorporating a first dynamic content item having a first duration time and a second dynamic content item having a second duration time shorter than the first duration time, such that execution of the second content item is repeatedly looped in parallel with the duration of the first content item during playback.

86. The method according to claim 80, wherein compiling the playback sequence comprises incorporating a static content item and a dynamic content item having a duration time, such that a display time of the static content item is held for a time period in parallel with the duration time of execution of the dynamic content item during playback.

87. The method according to claim 80, wherein compiling the playback sequence comprises arranging a first content item in series with a second content item and inserting a sprite track as a transition between the first and second content items during playback.

88. A method for producing media package on demand for delivery in real-time, comprising:
providing a plurality of media items each accessible from a data source according to a unique identifier;
defining a multi-linear sequencing script designating a plurality of modularized sequence slots for indicating a temporal and spatial arrangement of each of the plurality of media items relative to each other during playback of the media package;
compiling a playback sequence to assemble the media package according to the multi-linear sequencing script.

89. The method according to claim 88, wherein compiling the playback sequence comprises generating a series of pointers designating a respective media item for playback at an appropriate timing according to the multi-linear sequencing script.

90. The method according to claim 88, wherein compiling the playback sequence comprises incorporating both static and dynamic media items into the scripted playback sequence.

91. The method according to claim 88, wherein compiling the playback sequence comprises incorporating a first media item to be executed in series with a second media item.

92. The method according to claim 88, wherein compiling the playback sequence comprises incorporating a first media item in series with a second media item and inserting a sprite track or other digital element in transition between the first and second media items during playback.

93. The method according to claim 88, wherein compiling the playback sequence comprises incorporating a first media item to be executed in parallel with a second media item.

94. The method according to claim 93, wherein compiling the playback sequence comprises incorporating a third media item to be executed in series with at least one of the first media item and the second media item.

95. The method according to claim 88, further comprising delivering the media package for playback in real-time via cached multi-media server for streaming delivery.

96. The system according to claim 88, comprising selecting at least one media item to be incorporated into the media package to create the assembled media package on demand, wherein the selecting is performed by an end-user of the system.
